(19) United States
(12) Patent Application Publication
(10) Pub. No.: US 2025/0133605 A1
(43) Pub. Date: Apr. 24, 2025

(54) CONNECTION ESTABLISHMENT AND DUAL CONNECTIVITY COMMUNICATIONS OVER A WIRELESS LOCAL AREA NETWORK

(71) Applicant: QUALCOMM Incorporated, San Diego, CA (US)

(72) Inventors: Jianhua LIU, Beijing (CN); Peng CHENG, Beijing (CN); Gavin Bernard HORN, La Jolla, CA (US); Ozcan OZTURK, San Diego, CA (US); Rajat PRAKASH, San Diego, CA (US); Aziz GHOLMIEH, Del Mar, CA (US)

(21) Appl. No.: 18/688,303

(22) PCT Filed: Oct. 14, 2021
(86) PCT No.: PCT/CN2021/123737

§ 371 Date: Feb. 29, 2024

(51) Int. Cl. H04W 76/10; H04W 68/02; H04W 76/20; H04W 84/12

(52) U.S. Cl. CPC H04W 76/10; H04W 68/02; H04W 76/20; H04W 84/12

(57) ABSTRACT

Methods, systems, and devices for wireless communications are described. A wireless device may establish a radio resource control (RRC) connection over a wireless local area network (WLAN) link. For example, the wireless device may transmit a packet to an access point or WLAN termination that includes an RRC container including an RRC message for establishing (e.g., setting up, resuming) a connection with a centralized unit (CU). In some examples, the wireless device may additionally or alternatively be configured with dual connectivity over a WLAN link, including the addition, modification, and release of nodes associated with different radio access technologies. In such cases, the CU may configure connectivity with the WLAN, where the CU may configure a port number for each radio bearer via an RRC message transmitted over a direct link with the wireless device (e.g., via a distributed unit) or via the WLAN link.

### CROSS REFERENCE

The present Application is a 371 national stage filing of International PCT Application No. PCT/CN2021/123737 by LIU et al. entitled “CONNECTION ESTABLISHMENT AND DUAL CONNECTIVITY COMMUNICATIONS OVER A WIRELESS LOCAL AREA NETWORK,” filed Oct. 14, 2021, which is assigned to the assignee hereof, and which is expressly incorporated by reference in its entirety herein.

### FIELD OF TECHNOLOGY

The following relates to wireless communications, including connection establishment and dual connectivity communications over a wireless local area network.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications system may support UEs that are configured to communicate using different radio access technologies (RATs). As an example, a first node associated with a first network (e.g., a 5G radio access network (RAN)) may interface with a second node of a second network (e.g., a wireless local area network (WLAN)), and the UE may communicate with one or both of the first node and the second node using respective RATs associated with the networks. In some cases, however, there may be no mechanism to support the establishment, reestablishment, or both, of a connection with the first network over a communication link associated with the second network. Similarly, there may be limited techniques for the addition, modification, or release of nodes associated with one or both of the first and second networks.

### SUMMARY

The described techniques relate to improved methods, systems, devices, and apparatuses that support connection establishment and dual connectivity communications over a wireless local area network (WLAN). Generally, the described techniques provide for a wireless device (e.g., a user equipment (UE)) to establish a radio resource control (RRC) connection over a WLAN communication link. Specifically, the present disclosure provides techniques for the wireless device to transmit a packet to an access point (AP), WLAN termination (WT), or both, that includes an RRC container comprising an RRC message (e.g., RRCSetupRequest, RRCResumeRequest) for establishing or resuming a connection with a centralized unit (CU). In such cases, the AP or the WT may forward the connection establishment request from the UE to the CU, and the CU may, in turn, respond with an additional RRC message (e.g., RRCSetup), for example, in a container of a packet transmitted from the CU to the AP or WT. The additional RRC message may enable the establishment, or reestablishment, of an RRC connection with the CU via the WLAN communication link, where the AP, or WT, or both, may enable messaging to be exchanged between the UE and the CU in an efficient manner over an already-established WLAN link.

Aspects of the disclosure also describe techniques for a UE to be configured with dual connectivity over a WLAN link. For example, the UE may signal to a CU, via an AP or WT, or both, an identifier of a WLAN (e.g., service set identifier (SSID) or other identifier), and the CU may determine to initiate dual connectivity for the UE based on the identifier. In such cases, the CU may configure the UE connectivity with the WLAN. In some aspects, WLAN modification may occur under various trigger conditions, such as signaling sent to the CU indicating updated WLAN identifiers, the UE reselecting another AP (e.g., associated with a different SSID), or the CU determining to modify the configuration. Similarly, the WLAN connection configuration may be released in cases where the UE loses a connection with the AP or WT, based on a local configuration, or a request received from the UE, among other examples.

A method for wireless communication is described. The method may include transmitting, by a UE, a first packet to a node that is associated with a first radio access technology including a wireless local area network, where the first packet includes a first control message requesting establishment of a connection with a network node, receiving, from the node, a second packet in response to the first control message, where the second packet includes a second control message for establishing the connection between the UE and the network node, and establishing the connection with the network node over a communication link associated with the first radio access technology based on the second control message.

An apparatus for wireless communication is described. The apparatus may include a processor and memory coupled with the processor, where the memory may have instructions stored in the memory. The instructions may be executable by the processor to cause the apparatus to transmit, by a UE, a first packet to a node that is associated with a first radio access technology including a wireless local area network, where the first packet includes a first control message requesting establishment of a connection with a network node, receive, from the node, a second packet in response to the first control message, where the second packet includes a second control message for establishing the connection between the UE and the network node, and establish the connection with the network node over a communication link associated with the first radio access technology based on the second control message.

Another apparatus for wireless communication is described. The apparatus may include means for transmitting, by a UE, a first packet to a node that is associated with a first radio access technology including a wireless local area network, where the first packet includes a first control message requesting establishment of a connection with a network node, means for receiving, from the node, a second packet in response to the first control message, where the second packet includes a second control message for establishing the connection between the UE and the network node, and means for establishing the connection with the network node over a communication link associated with the first radio access technology based on the second control message.

A non-transitory computer-readable medium storing code for wireless communication is described. The code may include instructions executable by a processor to transmit, by a UE, a first packet to a node that is associated with a first radio access technology including a wireless local area network, where the first packet includes a first control message requesting establishment of a connection with a network node, receive, from the node, a second packet in response to the first control message, where the second packet includes a second control message for establishing the connection between the UE and the network node, and establish the connection with the network node over a communication link associated with the first radio access technology based on the second control message.

Some examples of the method, apparatuses, and non-transitory computer-readable medium described herein may further include operations, features, means, or instructions for transmitting, to the node, a third packet including a third control message, where the connection with the network node may be established over the communication link based on the third control message.

In some examples of the method, apparatuses, and non-transitory computer-readable medium described herein, the third control message includes a radio resource control setup complete message.

Some examples of the method, apparatuses, and non-transitory computer-readable medium described herein may further include operations, features, means, or instructions for encapsulating the first control message in a radio resource control container, where the first packet includes the radio resource control container.

In some examples of the method, apparatuses, and non-transitory computer-readable medium described herein, transmitting the first packet to the node may include operations, features, means, or instructions for determining an address of the node and transmitting the first packet having an address field that includes a destination address including the address of the node.

In some examples of the method, apparatuses, and non-transitory computer-readable medium described herein, the address of the node includes a medium access control (MAC) address, or an Internet protocol (IP) address, or any combination thereof.

In some examples of the method, apparatuses, and non-transitory computer-readable medium described herein, transmitting the first packet to the node may include operations, features, means, or instructions for determining an address of the network node and transmitting the first packet having an address field that includes a destination address including the address of the network node.

In some examples of the method, apparatuses, and non-transitory computer-readable medium described herein, the address of the network node includes a MAC address, or an IP address, or any combination thereof.

In some examples of the method, apparatuses, and non-transitory computer-readable medium described herein, transmitting the first packet to the node may include operations, features, means, or instructions for determining that one or more coverage conditions may have been satisfied, where the one or more coverage conditions include the UE being outside a coverage of a second radio access technology associated with the network node, or the coverage of the second radio access technology satisfying a threshold, or a signal quality of the first radio access technology being greater than a signal quality of the second radio access technology, or any combination thereof and transmitting the first packet including the first control message based on determining that the one or more coverage conditions may have been satisfied.

In some examples of the method, apparatuses, and non-transitory computer-readable medium described herein, transmitting the first packet to the node may include operations, features, means, or instructions for identifying policy information configuring the UE to transmit the first packet to the node, the policy information being configured per service, or per cell type, or per application, or per network slice, or any combination thereof and transmitting the first packet including the first control message based on the policy information.

Some examples of the method, apparatuses, and non-transitory computer-readable medium described herein may further include operations, features, means, or instructions for receiving non-access stratum signaling configuring the policy information, where the policy information may be identified based on the non-access stratum signaling.

In some examples of the method, apparatuses, and non-transitory computer-readable medium described herein, the policy information may be preconfigured for the UE based on one or more subscriptions.

In some examples of the method, apparatuses, and non-transitory computer-readable medium described herein, transmitting the first packet to the node may include operations, features, means, or instructions for determining that an access request transmitted to the network node may have failed based on a random access failure, or access control barring, or a barred cell, or any combination thereof and transmitting the first packet including the first control message based on the failed access request.

In some examples of the method, apparatuses, and non-transitory computer-readable medium described herein, transmitting the first packet to the node may include operations, features, means, or instructions for determining that a radio resource control connection with the network node may have been rejected and transmitting the first packet including the first control message based on the rejected radio resource control connection.

In some examples of the method, apparatuses, and non-transitory computer-readable medium described herein, transmitting the first packet to the node may include operations, features, means, or instructions for receiving an redirection indication from the network node, the redirection indication including an indication for the UE to request the establishment of the connection with the network node over the communication link and transmitting the first packet including the first control message based on the redirection indication.

In some examples of the method, apparatuses, and non-transitory computer-readable medium described herein, transmitting the first packet to the node may include operations, features, means, or instructions for receiving, from the node, a paging message including an indication to request the establishment of the connection with the network node over the communication link and transmitting the first packet including the first control message based on the received paging message.

In some examples of the method, apparatuses, and non-transitory computer-readable medium described herein, the first control message includes a radio resource control setup request message or a radio resource control resume request message and the second control message includes a radio resource control setup message.

In some examples of the method, apparatuses, and non-transitory computer-readable medium described herein, the UE may be configured to support communications via the first radio access technology and a second radio access technology.

In some examples of the method, apparatuses, and non-transitory computer-readable medium described herein, the second radio access technology includes a new radio (NR) radio access technology and the network node includes a centralized unit (CU).

In some examples of the method, apparatuses, and non-transitory computer-readable medium described herein, the node includes an AP, or a WT, or any combination thereof.

A method for wireless communication is described. The method may include receiving, by a network node associated with a first radio access technology, a first packet from a node associated with a second radio access technology, the second radio access technology including a wireless local area network, where the first packet includes a first control message from a UE configured for communications via the first radio access technology and the second radio access technology and transmitting, to the node associated with the second radio access technology, a second packet including a second control message for establishing a connection between the network node and the UE over a communication link associated with the second radio access technology based on decoding the first control message.

An apparatus for wireless communication is described. The apparatus may include a processor and memory coupled with the processor, where the memory may have instructions stored in the memory. The instructions may be executable by the processor to cause the apparatus to receive, by a network node associated with a first radio access technology, a first packet from a node associated with a second radio access technology, the second radio access technology including a wireless local area network, where the first packet includes a first control message from a UE configured for communications via the first radio access technology and the second radio access technology and transmit, to the node associated with the second radio access technology, a second packet including a second control message for establishing a connection between the network node and the UE over a communication link associated with the second radio access technology based on decoding the first control message.

Another apparatus for wireless communication is described. The apparatus may include means for receiving, by a network node associated with a first radio access technology, a first packet from a node associated with a second radio access technology, the second radio access technology including a wireless local area network, where the first packet includes a first control message from a UE configured for communications via the first radio access technology and the second radio access technology and means for transmitting, to the node associated with the second radio access technology, a second packet including a second control message for establishing a connection between the network node and the UE over a communication link associated with the second radio access technology based on decoding the first control message.

A non-transitory computer-readable medium storing code for wireless communication is described. The code may include instructions executable by a processor to receive, by a network node associated with a first radio access technology, a first packet from a node associated with a second radio access technology, the second radio access technology including a wireless local area network, where the first packet includes a first control message from a UE configured for communications via the first radio access technology and the second radio access technology and transmit, to the node associated with the second radio access technology, a second packet including a second control message for establishing a connection between the network node and the UE over a communication link associated with the second radio access technology based on decoding the first control message.

In some examples of the method, apparatuses, and non-transitory computer-readable medium described herein, the first packet may be received via a user plane and the method, apparatuses, and non-transitory computer-readable medium may include further operations, features, means, or instructions for receiving the first packet via a general packet radio service (GRPS) tunneling protocol-U (GTP-U) tunnel from the node, where the first packet includes a tunnel endpoint identifier (TEID) allocated to the UE.

In some examples of the method, apparatuses, and non-transitory computer-readable medium described herein, transmitting the second packet including the second control message may include operations, features, means, or instructions for transmitting the second packet via the GTP-U tunnel to the node, where a destination TEID of the second packet includes the TEID allocated to the UE.

Some examples of the method, apparatuses, and non-transitory computer-readable medium described herein may further include operations, features, means, or instructions for encapsulating the second control message in a radio resource control container, where the second packet includes the control container.

Some examples of the method, apparatuses, and non-transitory computer-readable medium described herein may further include operations, features, means, or instructions for receiving, from the node, a third packet including a third control message, the third control message including a radio resource setup complete message, where the connection between the network node and the UE may be established over the communication link based on the third control message.

In some examples of the method, apparatuses, and non-transitory computer-readable medium described herein, transmitting the second packet including the second control message may include operations, features, means, or instructions for determining an address of the UE, the address including a MAC address, or an IP address, or a UE association identifier, or any combination thereof and transmitting the second packet including the address of the UE.

A method for wireless communication is described. The method may include receiving, by a node associated with a first radio access technology, a first packet from a UE configured for communications via the first radio access technology and a second radio access technology, the first radio access technology including a wireless local area network, where the first packet includes a first control message requesting establishment of a connection between the UE and a network node associated with the second radio access technology and transmitting, to the network node associated with the second radio access technology, a second packet including the first control message for establishing the connection between UE and the network node based on receiving the first packet.

An apparatus for wireless communication is described. The apparatus may include a processor and memory coupled with the processor, where the memory may have instructions stored in the memory. The instructions may be executable by the processor to cause the apparatus to receive, by a node associated with a first radio access technology, a first packet from a UE configured for communications via the first radio access technology and a second radio access technology, the first radio access technology including a wireless local area network, where the first packet includes a first control message requesting establishment of a connection between the UE and a network node associated with the second radio access technology and transmit, to the network node associated with the second radio access technology, a second packet including the first control message for establishing the connection between UE and the network node based on receiving the first packet.

Another apparatus for wireless communication is described. The apparatus may include means for receiving, by a node associated with a first radio access technology, a first packet from a UE configured for communications via the first radio access technology and a second radio access technology, the first radio access technology including a wireless local area network, where the first packet includes a first control message requesting establishment of a connection between the UE and a network node associated with the second radio access technology and means for transmitting, to the network node associated with the second radio access technology, a second packet including the first control message for establishing the connection between UE and the network node based on receiving the first packet.

A non-transitory computer-readable medium storing code for wireless communication is described. The code may include instructions executable by a processor to receive, by a node associated with a first radio access technology, a first packet from a UE configured for communications via the first radio access technology and a second radio access technology, the first radio access technology including a wireless local area network, where the first packet includes a first control message requesting establishment of a connection between the UE and a network node associated with the second radio access technology and transmit, to the network node associated with the second radio access technology, a second packet including the first control message for establishing the connection between UE and the network node based on receiving the first packet.

In some examples of the method, apparatuses, and non-transitory computer-readable medium described herein, transmitting the second packet including the first control message may include operations, features, means, or instructions for determining an address of the UE, the address including a MAC address, or an IP address, or a UE association identifier, or any combination thereof and transmitting the second packet including the address of the UE.

In some examples of the method, apparatuses, and non-transitory computer-readable medium described herein, the second packet may be transmitted via a user plane and the method, apparatuses, and non-transitory computer-readable medium may include further operations, features, means, or instructions for allocating a TEID to the UE and transmitting the second packet via a GTP-U tunnel to the network node associated with the second radio access technology, where the second packet includes the TEID allocated to the UE.

### BRIEF DESCRIPTION OF THE DRAWINGS

FIG. 1 illustrates an example of a wireless communications system that supports connection establishment and dual connectivity communications over a wireless local area network (WLAN) in accordance with aspects of the present disclosure.

FIGS. 2 and 3 illustrate examples of an architecture and protocol in a system that supports connection establishment and dual connectivity communications over a WLAN in accordance with aspects of the present disclosure.

FIG. 4 illustrates an example of a wireless communications system that supports connection establishment and dual connectivity communications over a WLAN in accordance with aspects of the present disclosure.

FIGS. 5 through 8 illustrates example of a process flow in a system that supports connection establishment and dual connectivity communications over a WLAN in accordance with aspects of the present disclosure.

FIGS. 9 and 10 show block diagrams of devices that support connection establishment and dual connectivity communications over a WLAN in accordance with aspects of the present disclosure.

FIG. 11 shows a block diagram of a communications manager that supports connection establishment and dual connectivity communications over a WLAN in accordance with aspects of the present disclosure.

FIG. 12 shows a diagram of a system including a device that supports connection establishment and dual connectivity communications over a WLAN in accordance with aspects of the present disclosure.

FIGS. 13 and 14 show block diagrams of devices that support connection establishment and dual connectivity communications over a WLAN in accordance with aspects of the present disclosure.

FIG. 15 shows a block diagram of a communications manager that supports connection establishment and dual connectivity communications over a WLAN in accordance with aspects of the present disclosure.

FIGS. 16 and 17 show block diagrams of devices that support connection establishment and dual connectivity communications over a WLAN in accordance with aspects of the present disclosure.

FIG. 18 shows a block diagram of a communications manager that supports connection establishment and dual connectivity communications over a WLAN in accordance with aspects of the present disclosure.

FIG. 19 shows a diagram of a system including a device that supports connection establishment and dual connectivity communications over a WLAN in accordance with aspects of the present disclosure.

FIGS. 20 through 24 show flowcharts illustrating methods that support connection establishment and dual connectivity communications over a WLAN in accordance with aspects of the present disclosure.

### DETAILED DESCRIPTION

A UE may establish a connection with a network node (e.g., a control unit (CU) or a distributed unit (DU)) and communicate with the network node over multiple communication links using different radio access technologies (RATs) (e.g., a cellular network link such as a new radio (NR) cellular network link and a wireless local area network (WLAN) link). As an example, a base station associated with a radio access network (RAN) (e.g., a 5G NR RAN) and may include a CU and one or more DUs, where the CU may be connected to one or more WLAN nodes (e.g., access points (APs)) using a transparent mode (e.g., using a connection via internet protocol (IP) routing) or an integrated mode (e.g., the WLAN AP may be coupled to a WLAN termination (WT) node that provides a dedicated interface to the CU). In some examples, the UE may communicate using the different RATs using a dual connectivity configuration.

In some cases, the UE may be outside of a coverage area corresponding to the CU, or the UE may experience poor signaling quality when connected to the CU (e.g., the WLAN may provide relatively better signal quality). In such cases, UE may utilize the WLAN to communicate with the 5G RAN. In some examples, however, there may be no mechanism to support the establishment or reestablishment of a connection with the 5G RAN over the WLAN link. Similarly, there may be limited techniques for the addition, modification, or release of a WT and/or DU for dual-connectivity communications.

Aspects of the present disclosure describe procedures for a UE to establish a radio resource control (RRC) connection over a WLAN link. Specifically, the present disclosure provides techniques for the UE to transmit a packet to an AP, WT, or both, that includes an RRC container with an RRC message (e.g., RRCSetupRequest, RRCResumeRequest) for establishing or resuming a connection with a CU associated with the 5G RAN. In some examples, the packet transmitted by the UE may include a destination address of the AP, WT, CU, or some combination thereof. The AP/WT may receive the packet from the UE and forward the RRC container to the CU. The CU may receive and decode the message within the RRC container, and subsequently send a packet back to the UE (e.g., via the AP/WT) including an RRC container that includes another RRC message (e.g., RRCSetup). The AP/WT may accordingly transmit the RRC container to the UE, thus enabling connection establishment with the radio access technology over the WLAN link. For instance, the UE may transmit another packet to the CU (e.g., via the AP/WT) with an RRC setup complete message as a payload of the packet (e.g., within an RRC container).

Aspects of the disclosure also describe techniques for a UE to be configured with dual connectivity over a WLAN link. For example, the UE may signal to a CU, via an AP/WT, an identifier of a WLAN (e.g., a service set identifier (SSID) or other identifier), and the CU may initiate dual connectivity communications for the UE based on the identifier. In such cases, the CU may configure the UE connectivity with the WLAN, where the CU may configure a port number for radio bearers via an RRC message transmitted over a direct link with the UE (e.g., via a DU) or via the WLAN link with the AP/WT. In some aspects, WLAN modification may occur under various trigger conditions, such as signaling sent to the CU indicating updated WLAN identifiers, the UE reselecting another AP (e.g., associated with a different SSID), or the CU determining to modify the configuration. Similarly, the WLAN connection configuration may be released in cases where the UE loses a connection with the AP/WT, based on a local configuration, or a request received from the UE.

Various aspects of the subject matter described herein may be implemented to realize one or more advantages. For example, the described techniques may support improvements in establishing and reestablishing wireless connections with various networks, such as in cases when wireless devices may experience relatively poor signal quality with a particular network. More specifically, by enabling a UE to establish a connection (e.g., an RRC connection) with a network (e.g., a 5G NR RAN, or another RAN) over a WLAN link, a UE may achieve communications with the network with increased reliability and reduced latency. In addition, dual connectivity configurations may be more efficiently modified through the use of signaling over the WLAN link including, for example, the addition, modification, release, or any combination thereof, of WLANs and DUs associated with dual connectivity communications by the UE. The improved efficiency achieved by the described signaling over the WLAN link in accordance with the described techniques may enable increased data rates and improved spectral efficiency. Thus, the supported techniques may include improved UE and network operations and may promote efficiencies in wireless communications, among other benefits.

Aspects of the disclosure are initially described in the context of wireless communications systems. Aspects of the disclosure are further illustrated by and described with reference to process flows. Aspects of the disclosure are further illustrated by and described with reference to apparatus diagrams, system diagrams, and flowcharts that relate to connection establishment and dual connectivity communications over a WLAN.

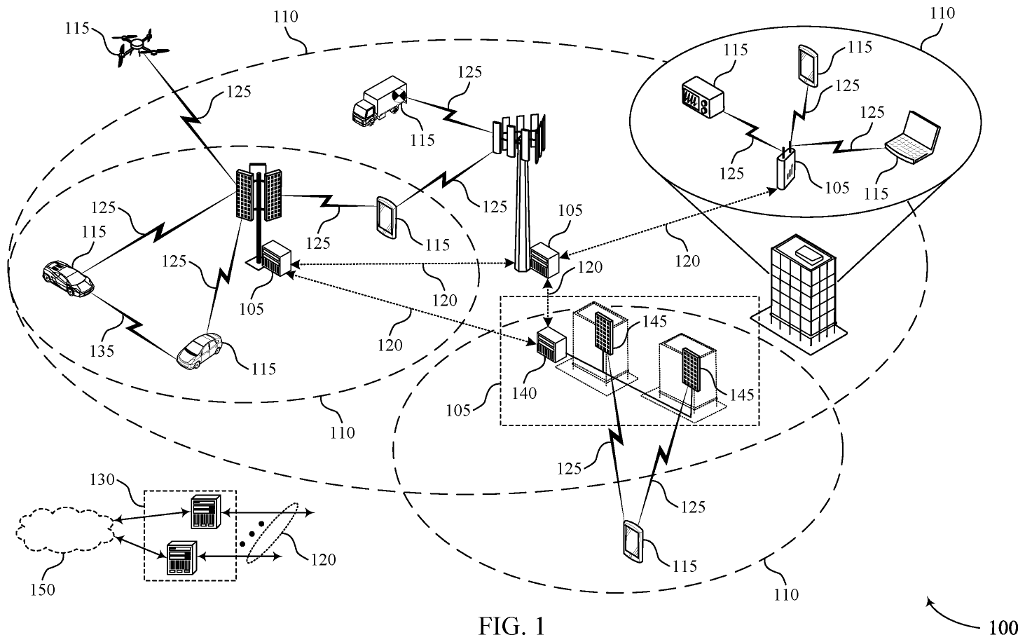

FIG. 1 illustrates an example of a wireless communications system 100 that supports connection establishment and dual connectivity communications over a WLAN in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a geographic coverage area 110 over which the UEs 115 and the base station 105 may establish one or more communication links 125. The geographic coverage area 110 may be an example of a geographic area over which a base station 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (RAT) (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

Wireless communications system 100 may support dual connectivity communications, for example, using different RATs. In the course of communications involving a dual connectivity connection (e.g., involving an NR link and an 802.11 WLAN link), a primary connection may be established. The UE 115, a network node, or other device may establish either link to be the primary link. The UE 115 may employ a single RRC connection with a network entity over both links of the dual connectivity connection. In some cases, the UE 115 may have a single RRC state (e.g., RRC_IDLE or RRC_CONNECTED), and the UE 115 may determine an RRC state considering both links, or may determine the RRC state using the primary link only. In the case of a link failure, the UE 115 may report the link failure of one of the links in the dual connectivity connection.

The wireless communications system 100 may include one or more APs of different types (e.g., metropolitan area, home network, etc.), with varying and overlapping coverage areas. Two UE 115 may also communicate directly via a direct wireless link regardless of whether both UEs 115 are in the same coverage area. Examples of direct wireless links may include Wi-Fi Direct connections, Wi-Fi Tunneled Direct Link Setup (TDLS) links, and other group connections. UEs 115 and APs may communicate according to the WLAN radio and baseband protocol for physical and medium access control (MAC) layers from IEEE 802.11 and versions including, but not limited to, 802.11b, 802.11g, 802.11a, 802.11n, 802.1 lac, 802.1 lad, 802.11ah, 802.11 ax, and so forth. In other implementations, peer-to-peer connections or ad hoc networks may be implemented within the wireless communications system 100.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or packet data convergence protocol (PDCP) layer may be IP-based. A radio link control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

Wireless communications system 100 may support integration of one or more RATs. For example, an E-UTRAN may support LTE-WLAN aggregation (LWA) operations where a UE 115 in RRC_CONNECTED is configured by an eNodeB to use radio resources of both LTE and WLAN. In some cases, two scenarios may be supported depending on a backhaul connection between LTE and WLAN. For example, one scenario may correspond to a non-co-located LWA scenario for a non-ideal backhaul. In such a scenario, a WT may terminate the Xw interface. A second scenario may correspond to a co-located LWA scenario for an ideal/internal backhaul. It is noted that the aspects described with reference to LTE and LWA may be expanded to other RATs, such as 5G NR and other wireless communications technologies.

In LWA, a radio protocol architecture that a bearer uses may depend on the LWA backhaul scenario and how the bearer is set up. For example, two bearer types may exist for LWA (e.g., split LWA bearer and switched LWA bearer), where downlink and uplink operations may be performed in concert with the LWA operation. For example, in downlink, for protocol data units (PDUs) sent over WLAN in an LWA operation, the LWA access point (LWAAP) entity may generate LWAAP PDUs including a data radio bearer (DRB) identity, where a WT forwards the data to a wireless device (e.g., the UE 115) over WLAN. In some examples, the UE 115 may utilize an LWA EtherType to determine that a received PDU corresponds to an LWA bearer, where the UE 115 may use the DRB identity to determine which LWA bearer the PDU corresponds to.

Similarly, in uplink, for PDUs sent over WLAN in an LWA operation, the LWAAP entity in the UE 115 may generate an LWAAP PDU including a DRB identity, where the UE 115 may use the LWA EtherType for sending data over WLAN. LWA may support split bearer operations where the PDCP sublayer supports in-sequence delivery of upper layer PDUS based on a reordering procedure introduced for dual connectivity (DC) operations. For example, DC may be configured at the UE 115 to utilize one or more nodes (e.g., a main node (MN) and a secondary node (SN)). In some cases, an SN may be added during an addition procedure initiated by the MN to establish a UE context at the SN to provide resources from the SN to the UE 115. In some examples, bearers may request secondary cell group (SCG) radio resources, where a procedure is used to add at least an initial SCG serving cell of the SCG. This procedure may also be used to configure an SN terminated main cell group (MCG) bearer (e.g., where no SCG configuration is needed). In some examples, the procedure to set up MN and SNs may be utilized for LTW-WLAN aggregation. For example, the wireless communications system 100 may perform a WT addition preparation procedure, where the WT addition preparation procedure may be initiated at the base station 105 to request the WT to establish one or more LWA bearers for the UE 115. The base station 105 may send an WT addition request message to the WT, which may include the one or more LWA bearers for the UE 115. If one or more general packet radio service (GPRS) tunneling protocol-user (GTP-U) tunnels at the WT have been established successfully, the WT may respond with a WT addition request acknowledge message, which may include successfully established and failed to be established bearers for LWA. In cases where WT addition is not successful, the WT may respond with a WT addition request reject message.

In some cases, however, there may exist no solution to address NR-WLAN DC operations for transparent and integrated modes. This may include WLAN discovery and selection, WLAN and DU addition, WLAN and DU modification, and WLAN and DU release.

Wireless communications system 100 may utilize next-generation RAN (NG-RAN) technology to support communications between one or more devices (e.g., the UE 115 and the base station 105). In some cases, an NG-RAN may include a set of gNodeBs (gNBs) connected to a 5G core (5GC) network via a next-generation interface (e.g., 5G NR). In some cases, the NG-RAN may also include a set of next-generation eNodeBs (NG-eNBs), where an NG-eNB may include an NG-eNB central unit (NG-eNB-CU) and one or more NG-eNB distributed units (NG-eNB-DUs). An NG-eNB-CU and an NG-eNB-DU may be connected via a W1 interface.

In some cases, a gNB may include a gNB-CU and one or more gNB-DUs, where the gNB-CU and a gNB-DU may be connected through an F1 interface (e.g., an open interface supporting an exchange of signaling and data information between endpoints in a network). In some examples, a gNB-DU may be connected to one gNB-CU. A gNB may support FDD, TDD, or dual mode operation. Additionally or alternatively, the gNB may be interconnected through an Xn interface.

Some devices within the wireless communications system 100 may utilize techniques for communicating with disaggregated RAN nodes over one or more radio access technologies (RATs). For example, the UE 115 may communicate with a 5G RAN node via a WLAN network (e.g., via an access point, a WT, or both). Such techniques may promote RRC connection reliability when a DU is deployed in millimeter wave (mmWave) frequency bands. Additionally, such techniques may provide for control plane reliability. For example, control plane messages may be duplicated through both NR and WLAN, may be reliably dynamic (e.g., when switching between NR and WLAN), may reliably perform transmission selection or reselection between NR and WLAN, or a combination thereof. Additionally or alternatively, the aforementioned techniques may provide for minimum data loss at the user plane while keeping legacy WLAN unchanged.

An example of an architecture and protocol that may support utilizing disaggregated RAN nodes over one or more RATs may correspond to a transparent mode between two or more RATs. For example, a UE may communicate via both 5G NR and WLAN by utilizing PDCP as an anchor while reusing existing PDCP functionality. For example, an enhanced CU (e.g., 5G) may utilize the PDCP, which may be configured to send data to a network wireless application protocol (NWAP), to communicate a bearer identifier (ID) to a UE 115 via one or more WLAN network nodes. In some cases, the CU may optionally add an internet protocol (IP) layer using IP routing over WLAN. In other cases, if no IP is available, the CU may utilize an Ethernet layer-2 switch to route information via WLAN.

As another example, a CU may utilize an integrated mode for NR-WLAN integration. In some cases, using PDCP as an anchor, the CU, the UE 115, or both, may reuse PDCP existing functionality. As in the previous example, the PDCP may be configured to send data to NWAP. In this example, however, the NWAP may utilize an Xw interface as baseline, with enhancement for RRC container forwarding as defined in F1AP or use GTP-U tunnel to the WT to achieve F1 or Xw-like functionality to forward data over WLAN from the CU to the UE 115.

In some cases, however, there may not exist a mechanism to support the UE 115 establishing an RRC connection over a WLAN link. Aspects of the present disclosure provide for establishment (e.g., RRC setup, RRC resume) of an RRC connection over a WLAN link and for how the UE 115 may determine to establish the RRC connection over the WLAN link. Additionally, aspects of the present disclosure may also provide for one or more procedures corresponding to DC operations in NR-WLAN. For example, the present disclosure may provide for WT and DU addition procedures, WT and DU modification procedures, and WT and DU release procedures.

In some cases, wireless communications system 100 may support techniques for a wireless device (e.g., a UE 115) to establish an RRC connection over a WLAN link. Specifically, the present disclosure provides techniques for the wireless device to transmit a packet to an AP/WT that includes an RRC container with an RRC message (e.g., RRCSetupRequest, RRCResumeRequest) for establishing and/or resuming a connection with a CU. In some examples, the packet transmitted by the UE 115 may have a destination address of the AP/WT or the CU. The AP/WT may forward the RRC container to a CU. The CU may receive and decode the message within the RRC container, and subsequently send a packet back to the UE 115 via the AP/WT including an RRC container that includes another RRC message (e.g., RRCSetup). The AP/WT may accordingly transmit the RRC container to the wireless device, to which the UE 115 may respond with an additional packet with another RRC message (e.g., RRCSetupComplete) encapsulated in an RRC container. The AP/WT may forward the contents of the additional packet to the CU, thus enabling connection establishment with the CU over the WLAN link.

Wireless communications system 100 may additionally or alternatively support techniques for a UE 115 to be configured with dual connectivity over a WLAN link. For example, the UE 115 may signal to a CU, via an AP/WT, an identifier of a WLAN (e.g., SSID or other identifier), and the CU may determine to initiate dual connectivity for the UE based on the identifier. In such cases, the CU may configure the UE connectivity with the WLAN, where the CU may configure a port number for each radio bearer via an RRC message transmitted over a direct link with the UE 115 (e.g., via a DU) or via the WLAN link with the AP/WT. In some aspects, WLAN modification may occur under various trigger conditions, such as signaling sent to the CU indicating updated WLAN identifiers, the UE reselecting another AP (e.g., associated with a different SSID), or the CU determining to modify the configuration. Similarly, the WLAN connection configuration may be released in cases where the UE loses a connection with the AP/WT, based on a local configuration, or a request received from the UE 115.

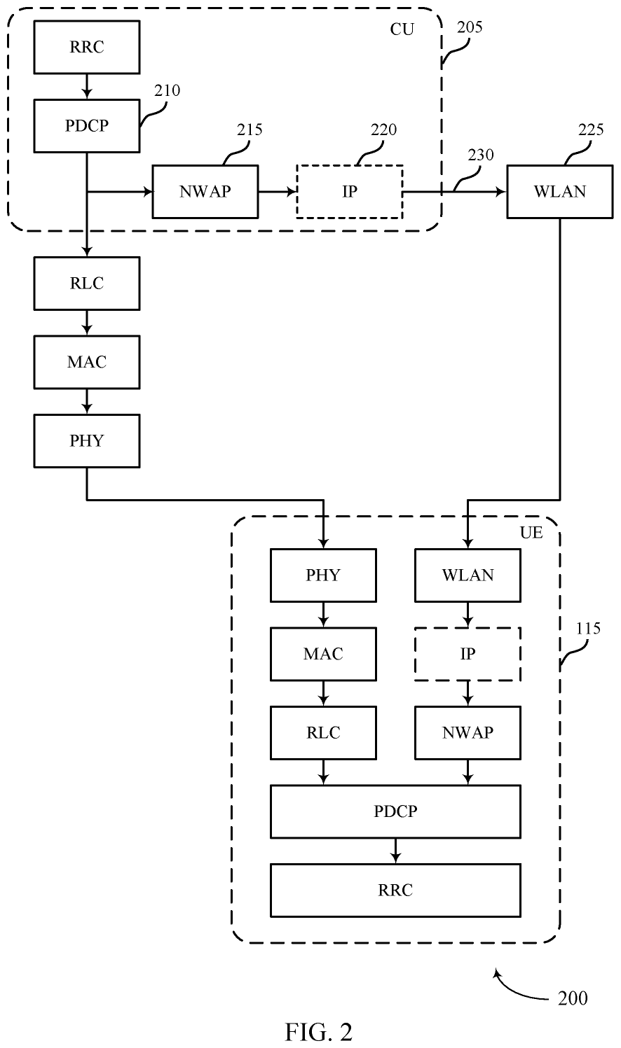

FIG. 2 illustrates an example of an architecture and protocol 200 in a system that supports connection establishment and dual connectivity communications over a WLAN in accordance with aspects of the present disclosure. The architecture and protocol 200 may be an example of an architecture in a wireless communications system including a CU 205 (e.g., a network node) and a UE 115. In some examples, the CU 205 may be associated with one or more base stations, where a base station and UE 115 may be examples of a base station 105 and a UE 115 described with reference to FIG. 1. In some examples, the CU 205 and the UE 115 may communicate using one or more protocol layers, as illustrated by the architecture and protocol 200.

In the architecture and protocol 200, various packets may be communicated between various communications protocols (e.g., protocol layers) including, for example, an RRC layer (e.g., for exchanging control information and other functions), a PDCP layer (e.g., for header compression/decompression, data transfer in the user plane or control plane, and other functions), an RLC layer (e.g., for transfer of upper layer PDUs, beam management, and other functions), a MAC layer (e.g., for mapping between physical and logical channels, error correction, and other functions), and a physical (PHY) layer (e.g., for carrying information from the MAC over the air interface), among others. In such cases, messages may be transmitted by one wireless device over PHY to another wireless device, where the message may be decoded and communicated between corresponding protocol layers at the receiving device.

In some examples, the architecture and protocol 200 may support disaggregated RAN nodes over one or more RATs, where the architecture and protocol 200 may be associated with a transparent mode supporting UE communications with two or more RATs. For example, the architecture and protocol 200 may enable 5G NR and WLAN communications between the UE 115 and CU 205. In such cases, PDCP 210 may be used as an anchor based on the functionality of the PDCP 210. Here, the CU 205 (e.g., an enhanced CU (e.g., supporting NR)) may utilize PDCP for communications with the UE 115 over a WLAN link, and the PDCP may be configured to send data to a NWAP 215. At the NWAP 215, a bearer ID may be added to the packet received from the PDCP 210 and the CU 205 may optionally add an IP layer 220. In such cases, the CU 205 may optionally add the IP layer 220 for IP routing over the WLAN link. In other cases, if IP is not available, the CU may utilize an Ethernet layer-2 switch to route information via WLAN 225. In either case, a packet may be transmitted to the WLAN 225 over an interface 230, and the packet may be transmitted to the UE 115 using a WLAN communication link. In some example, the interface 230 may be an example of an Ethernet interface between the WLAN 225 and the CU 205.

As described herein, a system implementing the architecture and protocol 200 may enable a UE 115 to communicate with different RATs using the transparent mode described herein. In some cases, however, the UE 115 may be unable to establish an RRC connection with the CU 205 over a WLAN link (e.g., via the WLAN 225). Additionally or alternatively, the UE 115 may be unable to reestablish (e.g., resume) an RRC connection with the CU 205 over the WLAN link. Further, WLAN discovery and selection in the transparent mode, including functionality for WLAN/DU addition, WLAN/DU modification, WLAN/DU release, or any combination thereof, may not be supported.

As described herein, a system using the architecture and protocol 200 may support techniques for the establishment or reestablishment, or both, of the RRC connection with the CU 205 over the WLAN communication link. In some aspects, RRC messages may be exchanged between the UE 115 and the CU 205 using the WLAN link, which may be communicated between the devices by an AP associated with the WLAN 225. For instance, the UE 115 may transmit a packet to an AP, and a payload of the packet may include an RRC container with an RRC message. The RRC message may be used by the UE 115 to request establishment (e.g., initial establishment or resumption) of an RRC connection with the CU 205. In such cases, the AP associated with the WLAN 225 may forward the RRC container as a payload of a packet to the CU 205, and the CU 205 may transmit additional messages to the UE 115, via the AP, to establish or resume the RRC connection. In some cases, the UE 115 may transmit the packet to the AP including the RRC container based on one or more triggers or conditions being satisfied.

The techniques described herein may also support modification of dual connectivity over a WLAN link in a system supporting the architecture and protocol 200. For example, the UE 115 may signal to the CU 205, via the AP, an identifier of a WLAN 225, and the CU 205 may initiate dual connectivity communications for the UE 115 based on the identifier. In such cases, the CU 205 may configure UE connectivity with the WLAN 225, where the CU 205 may configure a port number for radio bearers via an RRC message transmitted over a direct link with the UE 115 (e.g., via a DU) or via the WLAN link with the AP. In some aspects, WLAN modification may occur under various trigger conditions, such as signaling sent to the CU indicating updated WLAN identifiers, the UE 115 reselecting another AP (e.g., associated with a different SSID), or the CU 205 determining to modify the configuration, among others.

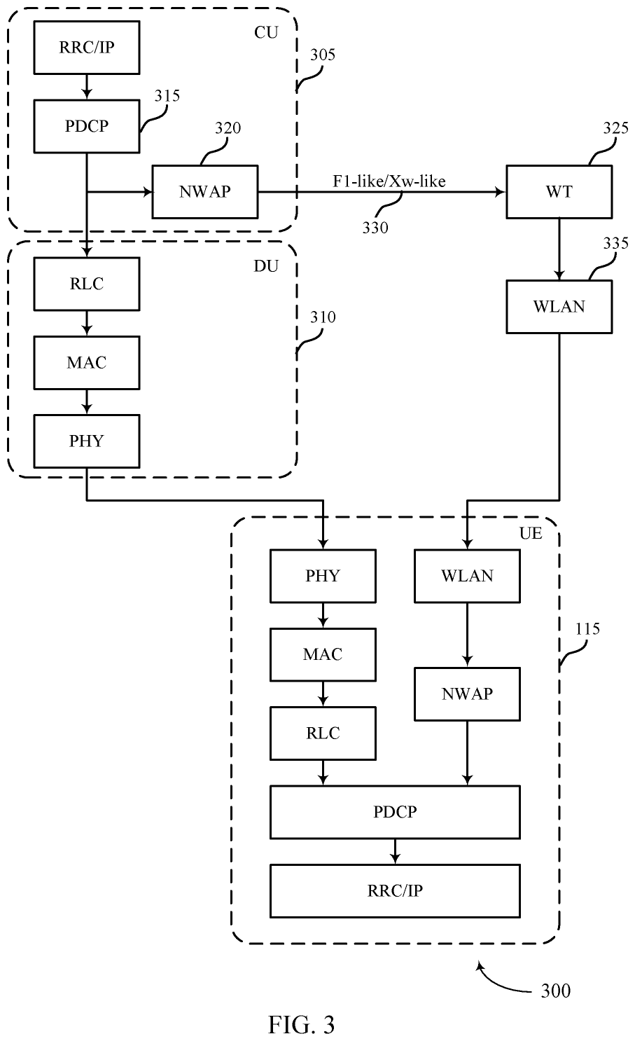

FIG. 3 illustrates an example of an architecture and protocol 300 in a system that supports connection establishment and dual connectivity communications over a WLAN in accordance with aspects of the present disclosure. The architecture and protocol 300 may be an example of an architecture in a wireless communications system including a CU 305 (e.g., a network node), a DU 310, and a UE 115. In some examples, the CU 305 and the DU 310 may be associated with one or more base stations, where a base station and UE 115 may be examples of a base station 105 and a UE 115 described with reference to FIG. 1. In some examples, the CU 305 and the UE 115 may communicate using one or more protocol layers, as illustrated by the architecture and protocol 300.

In the architecture and protocol 300, various packets may be communicated between various communications protocols (e.g., protocol layers) including, for example, an RRC layer (e.g., for exchanging control information and other functions), a PDCP layer, an RLC layer, a MAC layer, and a PHY layer, among others. In such cases, messages may be transmitted by one wireless device over PHY to another wireless device, where the message may be decoded and communicated between corresponding protocol layers at the receiving device. In the example illustrated by FIG. 3, some communications protocols (e.g., RRC, IP, PDCP, NWAP, or others) may be associated with the CU 305, while one or more other communication protocols (e.g., RCL, MAC, PHY, or others) may be associated with the DU 310.

In some examples, the architecture and protocol 300 may support disaggregated RAN nodes over one or more RATs, where the architecture and protocol 300 may be associated with an integrated mode supporting UE communications with two or more RATs. For example, the architecture and protocol 300 may enable 5G NR and WLAN communications between the UE 115 and CU 305. In such cases, PDCP 315 may be used as an anchor based on the functionality of the PDCP 315. Here, the CU 305 (e.g., an enhanced CU (e.g., supporting NR)) may utilize PDCP for communications with the UE 115 over a WLAN link, and the PDCP 315 may be configured to send data to a NWAP 320. At the NWAP 320, a bearer ID may be added to the packet received from the PDCP 315. The NWAP 320 may transmit a packet to a WT 325 associated with the WLAN 335, where the packet sent to the WT 325 may be communicated over an interface 330 (e.g., an Xw interface). In some examples, the interface 330 may be associated with one or more enhancements for RRC container forwarding (e.g., as defined in F1AP). Additionally or alternatively, the interface 330 may use a GTP-U tunnel to the WT 325 to achieve, for example, F1-like or Xw-like functionality to forward data over the WLAN 335 from the CU 305 to the UE 115.

As described herein, a system implementing the architecture and protocol 300 may enable a UE 115 to communicate with different RATs using the integrated mode described herein. In some cases, however, the UE 115 may be unable to establish an RRC connection with the CU 305 over a WLAN communication link (e.g., via the WLAN 335). Additionally or alternatively, the UE 115 may be unable to reestablish (e.g., resume) an RRC connection with the CU 305 over the WLAN link. Further, WLAN discovery and selection in the transparent mode, including functionality for WLAN/DU addition, WLAN/DU modification, WLAN/DU release, or any combination thereof, may not be supported.

However, as described herein, the system using the architecture and protocol 300 may support techniques for the establishment or reestablishment, or both, of the RRC connection with the CU 305 over the WLAN communication link. In some aspects, RRC messages may be exchanged between the UE 115 and the CU 305 using the WLAN communication link, which may be communicated between the respective devices by the WT 325. For instance, the UE 115 may transmit a packet to the WT 325, and a payload of the packet may include an RRC container with an RRC message. The RRC message may be used by the UE 115 to request establishment (e.g., initial establishment or resumption) of an RRC connection with the CU 305. In such cases, the WT 325 may forward the RRC container as a payload of a packet to the CU 305, and the CU 305 may transmit additional messages to the UE 115, via the WT 325, to establish or resume the RRC connection. In some cases, the UE 115 may transmit the packet to the WT 325 including the RRC container based on one or more triggers or conditions being satisfied.

The techniques described herein may also support modification of dual connectivity over a WLAN link in a system supporting the architecture and protocol 300. For example, the UE 115 may signal to the CU 305, via the WT 325, an identifier of a WLAN 335, and the CU 305 may initiate dual connectivity communications for the UE 115 based on the identifier. In such cases, the CU 305 may configure UE connectivity with the WLAN 335, where the CU 305 may configure a port number for radio bearers via an RRC message transmitted over a direct link with the UE 115 (e.g., via a DU) or via the WLAN link with the WT 325. In some aspects, WLAN modification may occur under various trigger conditions, such as signaling sent to the CU indicating updated WLAN identifiers, the UE 115 reselecting another WLAN 335 (e.g., associated with a different SSID), or the CU 305 determining to modify the configuration, among others.

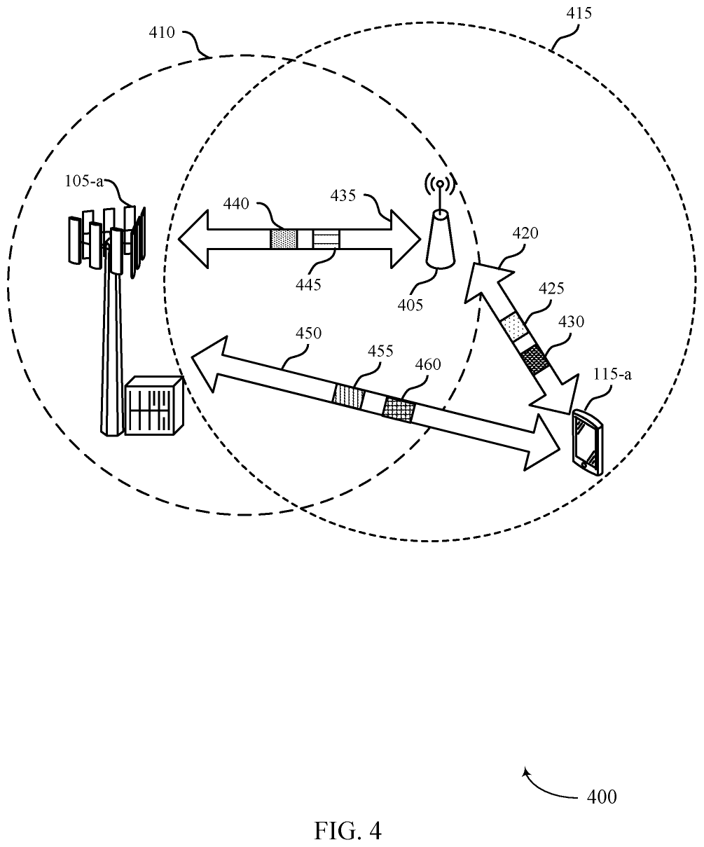

FIG. 4 illustrates an example of a wireless communications system 400 that supports connection establishment and dual connectivity communications over a WLAN in accordance with aspects of the present disclosure. The wireless communications system 400 may include a base station 105-a and a UE 115-a, which may be examples of a base station 105 and a UE 115 as described with reference to FIG. 1. The base station 105-a may correspond to a first RAT (e.g., 5G NR), while the UE 115-a may support communications over the first RAT and a second RAT (e.g., WLAN). The base station 105-a may include a CU and one or more DUs. The base station 105-a may provide communications services to devices within a geographic coverage area 410, while a node 405 (e.g., a WT, an AP) may provide communications services within a geographic coverage area 415. In some examples, the node 405 may provide WLAN resources for devices (e.g., the UE 115-a) to utilize for communications. In some cases, such as illustrated in FIG. 4, the UE 115-a may reside within the geographic coverage area 415, but outside the geographic coverage area 410. The UE 115-a, however, may additionally or alternatively be located within both the geographic coverage area 410 and the geographic coverage area 415. While operations and techniques may be discussed below as being performed by particular wireless devices, it is important to note that the operations and techniques may be performed by any number of wireless devices corresponding to different RATs, as well as different wireless devices and different RATs than those discussed below.

In some examples (e.g., in the integrated mode), the UE 115-a may discover and select a WLAN (e.g., the second RAT) to perform communications operations via the node 405. For example, the UE 115-a and the node 405 may establish and utilize a communication link 420 to exchange data. In some examples, the UE 115-a may derive an address associated with the node 405 (e.g., an AP, a WT, anther device associated with the WLAN) to enable one or more transmissions to the node 405. In some examples, the UE 115-a may determine that communications operations may be enhanced by establishing a connection with the first RAT (e.g., a connection with the base station 105-a). However, the UE 115-a may reside outside of the geographic coverage area 410, or the UE 115-a may experience relatively poor signal quality in the geographic coverage areas 410 of the base station 105-a. As such, the UE 115-a may not be able to establish a direct connection 450 (e.g., via a Uu interface) with the base station 105-a. The UE 115-a may, instead, transmit one or more messages via the node 405 to establish an indirect link with the base station 105-a and thus, the first RAT.

For example, the UE 115-a may transmit an RRC message via an RRC container 425 over the communication link 420 to the node 405, where the UE may set a destination address to the WT address (e.g., a MAC address or IP address). The node 405 may transmit a forwarded RRC container 440 to the base station 105-a via a communication link 435. In some examples, the base station 105-a may correspond to a CU within the first RAT. The base station 105-a may receive the forwarded RRC container 440 and subsequently decode the RRC message and send an RRC setup message to the WT in an RRC container 445. Based on the RRC container 445, the node 405 may transmit a second forwarded RRC container 430 to the UE 115-a. Based on the second forwarded RRC container 430, the UE 115-a may receive and transmit subsequent RRC messages utilizing similar operations. Thus, the UE 115-a may be provisioned resources to communicate over the first RAT via the node 405.

In another example (e.g., in the transparent mode), the UE 115-a may receive a system information (SI) message from a WLAN device (e.g., the node 405, which may be an example of an AP, WT, or any combination thereof). Based on the SI message received from the node 405, the UE 115-a may discover and select a WLAN network associated with the SI message. The UE 115-a may transmit an RRC container (e.g., RRCSetupRequest, RRCResumeRequest) to the base station 105-a over the WLAN network using Ethernet, an IP packet, or the like. In some cases, the UE 115-a may set a destination associated with the RRC container to the base station 105-a (e.g., MAC address, IP address). The node 405 may forward the RRC container as a payload to the base station 105-a according to the destination address. Upon receiving and decoding the payload, the base station 105-a may identify a MAC address or IP address associated with the UE 115-a based on a source address within the payload. The base station 105-a may generate an RRC setup message in response to the payload, and envelop a second payload into an Ethernet or IP packet with a set destination to the UE 115-a (e.g., via the MAC/IP address associated with the UE 115-a). The base station 105-a may transmit the second payload to the UE 115-a via the node 405, where the node 405 forwards the packet to the UE 115-a according to the destination address set by the base station 105-a.

In some cases, the UE 115-a may initiate RRC establishment over WLAN under one or more coverage conditions. For example, if the UE 115-a resides outside of Uu coverage (e.g., outside of the geographic coverage area 410), Uu coverage is under a configured threshold, WLAN link signal quality is relatively better than Uu coverage, or some combination thereof. Additionally or alternatively, the UE 115-a may initiate RRC establishment over WLAN based on a policy configured at the UE. The policy may be configured via non-access stratum (NAS) signaling, or may be preconfigured in the UE 115-a via subscription. The policy also may be configured per service (e.g., per call type, per application, per slice).

Additionally or alternatively, the UE 115-a may initiate RRC establishment over WLAN if the UE 115-a fails to access a CU via a DU (e.g., due to a random access channel (RACH) failure, access control barring, DU barring). In some cases, the UE 115-a may initiate RRC establishment over WLAN if an RRC connection is rejected, the CU redirects the UE 115-a with indication to WLAN, or both. Lastly, the UE 115-a may initiate RRC establishment over WLAN if the UE 115-a is paged and there is an indication in the paging to indicate steering to WLAN.

By determining to establish an RRC connection over a WLAN link, the UE 115-a may be afforded an efficient pathway for establishing a connection with the first RAT (e.g., 5G NR) utilizing robust signaling techniques associated with the second RAT (e.g., WLAN). This utilization may result in decreased latency, improved network reliability, and better user experience.

In some cases, however, the UE 115-a may be connected to the base station 105-a via the direct connection 450, where the base station 105-a may correspond to a DU utilizing the first RAT. During communications operations, the UE 115-a may discover and select an AP associated with WLAN (e.g., the second RAT) to establish WLAN connectivity in transparent mode. The UE 115-a may receive WLAN identifier information which may be included in a system information block (SIB) or dedicated RRC signaling. In some cases, the WLAN identifier may correspond to an SSID, where the UE 115-a discovers the AP via SSID broadcasts from the AP. Based on the SSID broadcasts, the UE 115-a may associate the SSID with the AP. In other cases, the UE 115-a may be preconfigured with the WLAN identifier information (e.g., basic SSID (BSSID), SSID, homogeneous extended SSID (HESSID)) by one or more subscriptions. In some examples, the WLAN identifier may be preconfigured for a specific public land mobile network (PLMN), non-public network (NPN), or both. When the UE 115-a registers with one PLMN or NPN, the UE 115-a may select the corresponding WLAN identifier. In another example, the UE 115-a may be provisioned with the WLAN identifier via a core network using registration or a UE configuration update (UCU) procedure.

In any case, the UE 115-a may transmit an RRC message 455 to a CU corresponding to the base station 105-a indicating a MAC or IP address to the base station 105-a. Additionally, or alternatively, the UE 115-a may indicate the SSID (or SSIDs) associated with the AP to the CU. The CU may determine to configure dual connectivity mode based on the RRC message 455. In such cases, the CU may add a WLAN link to the UE 115-a. In such cases, the dual connectivity mode may be duplication or a switching operation. The CU may configure dual connectivity mode to the UE 115-a via a second RRC message 460, which may include a MAC or IP address associated with the CU. The CU may also configure a port number for bearers within the dual connectivity configuration. The port number may be a source port number or a destination port number. In some cases, the second RRC message 460 may be transmitted over the direct connection 450 via the base station 105-a or over a new WLAN link. Additionally, or alternatively, the CU may select one SSID from an SSID list reported by the UE 115-a to configure the UE 115-a to discover the AP broadcasting the one SSID.

In some cases, the UE 115-a, the base station 105-a, the CU, or a combination thereof, may determine to modify WLAN connectivity in transparent mode. In some cases, WLAN modification may be performed under one or more trigger conditions. For example, the UE 115-a may be updated with WLAN identifier information (e.g., WLAN identifier is updated in SIB or by the core network via registration or a UCU procedure). The UE 115-a may send an RRC message to the CU indicating the updated WLAN identifiers, where the CU may modify the WLAN configuration. As another example, the UE 115-a may reselect to another AP broadcasting different WLAN identifiers (e.g., different SSID), where the UE 115-a may update the WLAN identifiers to the CU. Based on the updated WLAN identifiers, the CU may modify the WLAN configuration. As a third example, the CU may determine to modify the WLAN configuration based on local configurations (e.g., modifying a dual connectivity operation, such as duplication or switching, to one or more bearers).

In other cases, the UE 115-a may determine to release WLAN connectivity in transparent mode. Releasing WLAN connectivity may also be associated with one or more trigger conditions. For example, the UE 115-a may lose an AP connection (e.g., out of WLAN coverage, user switched off Wi-Fi, UE loses or cannot discover any AP broadcasting an associated WLAN identifier, or a combination thereof). The UE 115-a may indicate, to the CU, an occurrence of WLAN failure. Based on the indication, the CU may release WLAN connectivity. As another example, the CU may determine to release WLAN connectivity based on a local configuration. Lastly, the UE 115-a may transmit a request, to the CU, requesting the CU to release WLAN connectivity (e.g., in the case of low power at the UE 115-a, based on a network policy, based on user preference, or the like).

In some examples, such as during communications operations, the UE 115-a may discover and select an AP associated with WLAN (e.g., the second RAT) to establish WLAN connectivity in integrated mode. For example, the UE 115-a may receive WLAN identifier information included in SIB or dedicated RRC signaling, where the WLAN identifier information may correspond to BSSID, SSID, or HESSID. The UE 115-a may discover the AP broadcasting the BSSID, SSID, or HESSID, and associated the AP with the BSSID, SSID, or HESSID. In other cases, the UE 115-a may be preconfigured with the WLAN identifier information (e.g., BSSID, SSID, HESSID) by subscription. In some examples, the WLAN identifier may be preconfigured for a specific PLMN, NPN, or both. When the UE 115-a registers with one PLMN or NPN, the UE 115-a may select the corresponding WLAN identifier. In another example, the UE 115-a may be provisioned with the WLAN identifier via a core network using registration or a UCU.

The UE 115-a may transmit an RRC message to the CU indicating a set of selected WLAN identifiers (e.g., AP BBSID, WT address, BSSID). Based on the RRC message, the CU may determine to configure dual connectivity mode by adding a WLAN link to the UE 115-a, where the dual connectivity mode may be a duplication or switching operation. The CU may establish UE 115-a context in the node 405 based on WLAN identifier information indicated by the UE 115-a. For example, for each bearer, the CU may establish one GTP-U tunnel between the CU and the node 405. Alternatively, for signal radio bearers (SRBs), each RRC message may be carried in a control plane message on the interface of the node 405 and the CU. The CU may configure dual connectivity mode (e.g., duplication, switching) to the UE 115-a on a per bearer basis. In some cases, if the CU changes the node 405 or the AP, the CU may include a new WT or AP identifier within a configuration for each bearer. In some cases, if a new AP or WT is configured to the UE 115-a, the UE 115-a may associate with the configured AP or WT.

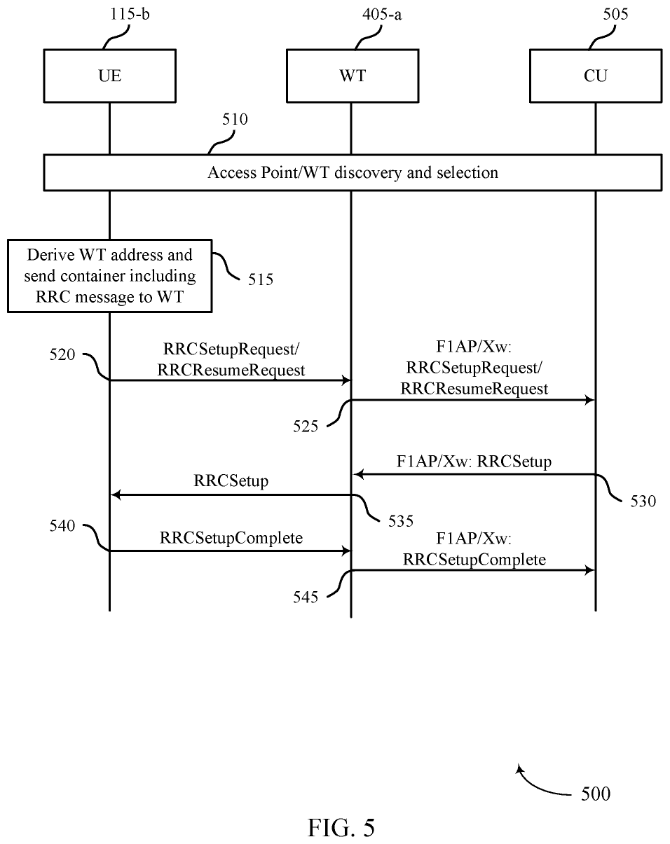

FIG. 5 illustrates an example of a process flow 500 in a system that supports connection establishment and dual connectivity communications over a WLAN in accordance with aspects of the present disclosure. The process flow 500 may be performed by one or more wireless devices, such as a base station and a UE 115-b, which may be examples of a base station 105 and a UE 115 as described with reference to FIGS. 1 and 4. In some examples, the process flow 500 may include one or more operations, signals, and procedures associated with the base station and the UE 115-b, as well as a WT 405-a (e.g., a node associated with a WLAN), which may be examples of the devices described with reference to FIGS. 2-4. In some examples, the base station may include a CU 505 and one or more DUs. While specific operations and techniques are discussed below, the operations and techniques may be performed in a different order than the example order shown, or the operations performed by the devices may be performed by different devices or at different times. The process flow 500 may support RRC connection establishment and reestablishment over a WLAN link in an integrated mode.

At 510, the UE 115-b, the CU 505, or both, may perform discovery and selection of a WLAN network corresponding to the WT 405-a. In some cases, the UE 115-b may determine to connect to the WT 405-a via an integrated mode. At 515, the UE 115-b may derive an address associated with the WT 405-a. Based on the address associated with the WT 405-a, the UE 115-b may generate an RRC container (e.g., which may include an RRCSetupRequest or RRCResumeRequest) to transmit to the WT 405-a associated with an AP. In some examples, the UE 115-b may set a destination address of the RRC container to the address associated with the WT 405-a (e.g., MAC address, IP address).

At 520, the UE 115-a may transmit the RRC container to the WT 405-a. In some examples, the UE 115-a may include a MAC address, IP address, association ID, or any combination thereof, associated with the UE 115-a in the packet including the RRC container (e.g., in an address field of the packet). At 525, the WT 405-a may forward the RRC container to the CU 505. In cases where the UE 115-b includes an address or associated ID, the WT 405-a may allocate a tunneling endpoint identifier (TEID) to the UE 115-b and transmit the RRC container via a GTP-U tunnel to the CU 505.

At 530, after receiving and decoding the RRC container, the CU 505 may transmit an RRC setup message to the WT 405-a in packet including a second RRC container (e.g., the second RRC container may include the RRC setup message). Optionally, the second RRC container may include an address associated with the UE 115-b, a UE associated ID, or both. In some cases, if the WT 405-a forwarded the RRC container to the CU 505 via a user plain, the CU 505 may send the second RRC container via a GTP-U tunnel to the WT 405-a, where the TEID may be the same as allocated, for example, at 520. In either case, at 535, the WT 405-a may transmit the second RRC container to the UE 115-b, where a destination address associated with the second RRC container may be set to an address associated with the UE 115-b (e.g., MAC or IP address).

At 540, the UE 115-a may transmit a packet including another RRC message (e.g., RRCSetupComplete) to the WT 405-a. In such cases, the RRC message may be encapsulated in an RRC container of the message. As similarly described above, the UE 115-b may set a destination address to WT address (e.g., MAC address or IP address) when transmitting the packet at 540.

At 545, the WT 405-a may forward the RRC setup complete message to the CU 505. Here, the WT 405-a may optionally include the UE address (e.g., MAC address, IP address, UE association ID, or the like). In some examples, if the RRC setup complete message sent to the CU 505 by the WT 405-a happens via the user plane, then the WT 405-a may allocate a TEID to the UE, and send the RRC container via the GTP-U tunnel to the CU 505. In such cases, the CU 505 may receive and decode the packet from the WT 405-a (e.g., that includes the RRCSetupComplete messages), enabling the establishment of an RRC connection with the UE 115-b via a WLAN communication link.

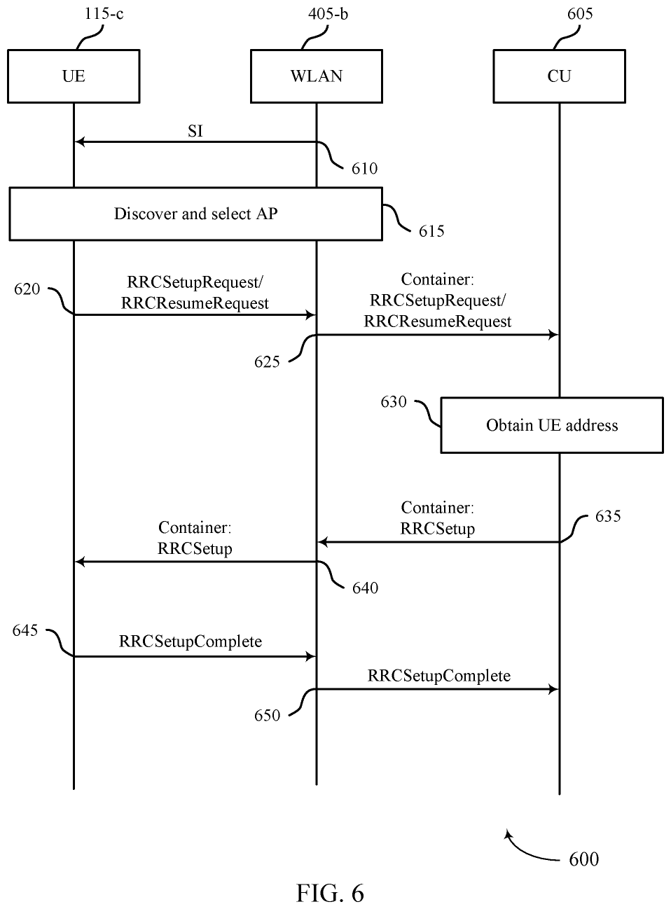

FIG. 6 illustrates an example of a process flow 600 in a system that supports connection establishment and dual connectivity communications over a WLAN in accordance with aspects of the present disclosure. The process flow 600 may be performed by one or more wireless devices, such as a base station and a UE 115-c, which may be examples of a base station 105 and a UE 115 as described with reference to FIGS. 1 and 4. In some examples, the process flow 600 may include one or more operations, signals, and procedures associated with the base station and the UE 115-c, as well as an AP 405-b (e.g., a node associated with a WLAN), which may be examples of the devices described with reference to FIGS. 2-4. In some examples, the base station may include a CU 605 and one or more DUs. While specific operations and techniques are discussed below, the operations and techniques may be performed in a different order than the example order shown, or the operations performed by the devices may be performed by different devices or at different times. The process flow 600 may support RRC connection establishment and reestablishment over a WLAN link in a transparent mode.

At 610, the UE 115-c may receive an SI from the CU 605 (e.g., associated with a 5G RAT), where the SI may include an address associated with the CU 605. For example, the SI may include a MAC address corresponding to the CU 605, an IP address corresponding to the CU 605, or both. At 615, the UE 115-c may discover and select a WLAN network corresponding to the AP 405-b. At 620, the UE 115-b may generate and transmit a payload including an RRC message (e.g., RRCSetupRequest, RRCResumeRequest) to establish a connection with the CU 605 over the WLAN, for example, using Ethernet or IP packets. In some cases, the RRC message may be included in an RRC container of the packet sent to the AP 405-b. In some cases, the UE 115-c may set a destination address (e.g., in an address field) associated with the payload to the address associated with the CU 605.

At 625, the AP 405-b may forward the payload (e.g., including an RRC container) to the CU 605 according to the destination address. At 630, the CU 605 may receive the payload and subsequently decode the RRC message associated with the payload. The CU 605 may identify the UE 115-c (e.g., a MAC address or IP address associated with the UE 115-c) based on a source address of the payload. The CU 605 may associate the MAC address or IP address with an identifier corresponding to the UE 115-c.

At 635, the CU may generate and transmit an RRC setup message, where the CU 605 may envelop a second payload (e.g., including the RRC setup message) into Ethernet or IP packets. Additionally, or alternatively, the CU 605 may set a destination address associated with the second payload to the MAC address, IP address, or both, associated with the UE 115-c. Based on generating the second payload, the CU 605 may forward the payload to the AP 405-b. At 640, the AP 405-b may forward the second payload to the UE 115-c according to the destination address.

At 645, the UE 115-c may transmit an RRC message (e.g., RRCSetupComplete) to the AP 405-b indicating successful receipt of the RRC setup message. In some examples, RRC message may be included in an RRC container. In other examples, a packet including the RRC message may be transmitted over the WLAN communication link using an ethernet or IP packet, where the UE 115-c may set the destination address to the CU address (e.g., MAC or IP address).

At 650, the AP 405-b may forward the RRC complete message to the CU 605. That is, the message from the AP 405-b to the CU 605 may include the container received from the UE 115-c. Based on the completion of RRC setup, the UE 115-c may perform communication operations over WLAN and 5G. That is, by communicating RRC messages via the AP 405-b, the UE 115-c and the CU 605 may establish (or resume) an RRC connection over a WLAN link.

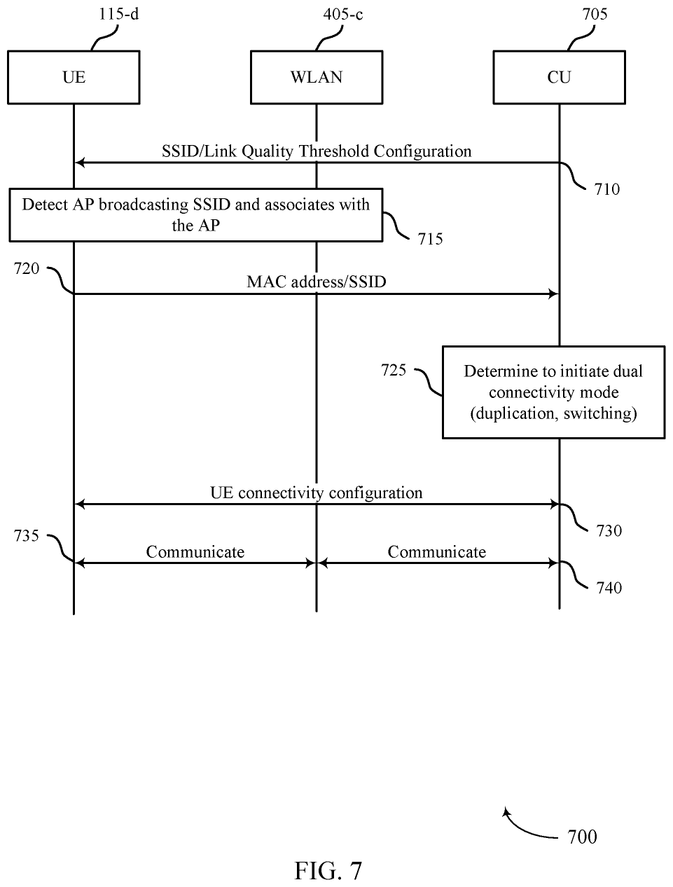

FIG. 7 illustrates an example of a process flow 700 in a system that supports connection establishment and dual connectivity communications over a WLAN in accordance with aspects of the present disclosure. The process flow 700 may be performed by one or more wireless devices, such as a base station and a UE 115-d, which may be examples of a base station 105 and a UE 115 as described with reference to FIGS. 1 and 4. In some examples, the process flow 700 may include one or more operations, signals, and procedures associated with the base station and the UE 115-d, as well as an AP 405-c (e.g., a node associated with a WLAN), which may be examples of the devices described with reference to FIGS. 2-4. In some examples, the base station may include a CU 705 and one or more DUs. While specific operations and techniques are discussed below, the operations and techniques may be performed in a different order than the example order shown, or the operations performed by the devices may be performed by different devices or at different times. The process flow 700 may support dual connectivity procedures over a WLAN link in a transparent mode.

At 710, the CU 705 may transmit, and the UE 115-d may receive, WLAN identifier information which may be included in a SIB or dedicated RRC signaling, or any combination thereof. In some cases, the WLAN identifier may include one or more SSIDs, where the UE 115-d may discover the WLAN via SSID broadcasts from the AP 405-c. In some examples, the UE 115-d may receive a configuration of a link quality threshold associated with the WLAN (e.g., which may be used when establishing a connection with the AP 405-c).

At 715, based on the SSID broadcasts, the UE 115-d may detect an AP (e.g., AP 405-c) broadcasting an SSID indicated by the CU 705 at 710. In such cases, the UE 115-d may associate with the AP 405-c based on the SSID. In other cases, the UE 115-d may be preconfigured with the WLAN identifier information (e.g., BSSID, SSID, HESSID) by subscription. In some examples, the WLAN identifier may be preconfigured for a specific PLMN, NPN, or both. When the UE 115-d registers with one PLMN or NPN, the UE 115-d may select the corresponding WLAN identifier. In another example, the UE 115-d may be provisioned with the WLAN identifier via a core network using registration or a UCU procedure.

At 720, the UE 115-d may transmit an RRC message to the CU 705 indicating a MAC address corresponding to the UE 115-d, an IP address corresponding to the UE 115-d, or both. In some examples, if a threshold is configured (e.g., signal quality at the AP 405-c is above a threshold), the UE 115-d may indicate WLAN identifiers to the CU 705, which may optionally indicate the SSID for which the WLAN identifiers are associated.

At 725, the CU 705 may determine to initiate and configure a dual connectivity mode for the UE 115-d by adding a WLAN link associated with the AP 405-c. The dual connectivity mode configured by the CU 705 may correspond to a duplication operation or a switching operation. At 730, the CU 705 may configure the dual connectivity mode at the UE 115-d. Additionally, the CU 705 may configure a port number for each bearer associated with the UE 115-d. For example, an RRC message including a configuration may be transmitted over an existing link (e.g., a Uu link between the CU 705 and the UE 115-d, a new WLAN link). In some cases, the CU 705 may select one SSID from an SSID list reported by the UE 115-d to configure the UE 115-d to discover the AP 405-c broadcasting with the one SSID (e.g., or another WLAN device broadcasting with the one SSID).

At 735, the UE 115-d may communicate with the AP 405-c utilizing the new WLAN link. In such cases, the communications may include messages including an NWAP PDU based on an address of the CU 705 (e.g., MAC address/IP address) and an address of the UE 115-d (e.g., MAC address/IP address). At 740, the AP 405-c may communicate with the CU 705, for example, using messages including an NWAP PDU based on an address of the CU 705 (e.g., MAC address/IP address) and an address of the UE 115-d (e.g., MAC address/IP address).

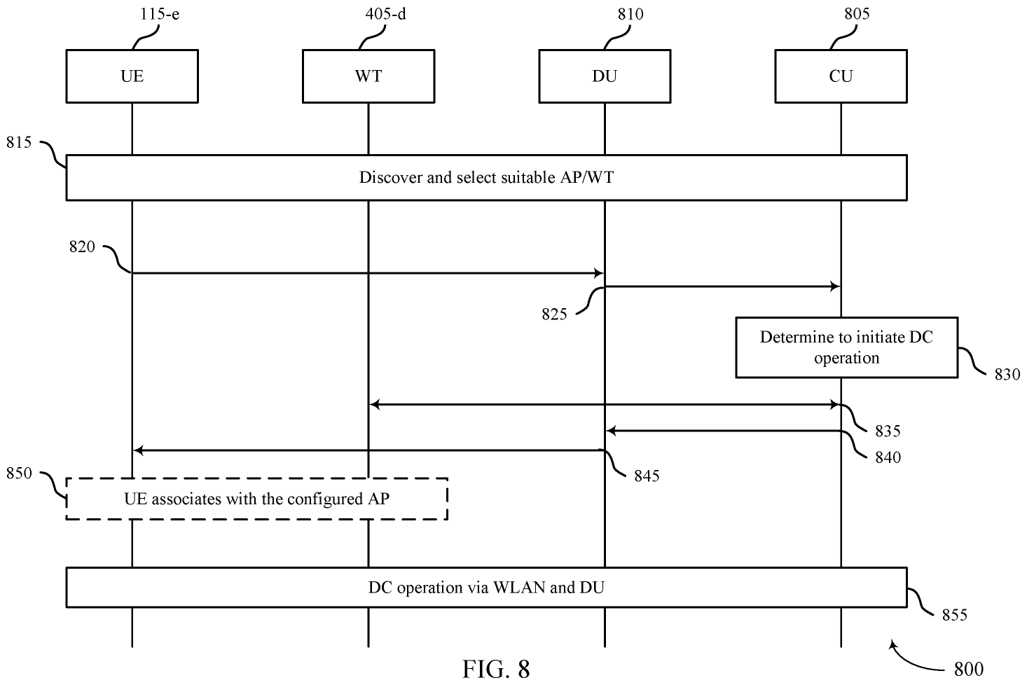

FIG. 8 illustrates an example of a process flow 800 in a system that supports connection establishment and dual connectivity communications over a WLAN in accordance with aspects of the present disclosure. The process flow 800 may be performed by one or more wireless devices, such as a base station and a UE 115-e, which may be examples of a base station 105 and a UE 115 as described with reference to FIGS. 1 and 4. In some examples, the process flow 800 may include one or more operations, signals, and procedures associated with the base station and the UE 115-e, as well as a WT 405-d (e.g., a node associated with a WLAN), which may be examples of the devices described with reference to FIGS. 2-4. In some examples, the base station may include a CU 805 and one or more DUs 810. While specific operations and techniques are discussed below, the operations and techniques may be performed in a different order than the example order shown, or the operations performed by the devices may be performed by different devices or at different times. The process flow 700 may support dual connectivity procedures over a WLAN link in an integrated mode.

At 815, the UE 115-e may discover and select the WT 405-d associated with a RAT (e.g., WLAN) to establish WLAN connectivity in the integrated mode. For example, the UE 115-a may receive WLAN identifier information included in SIB or dedicated RRC signaling, where the WLAN identifier information may correspond to BSSID, SSID, or HESSID. The UE 115-a may discover the AP broadcasting the BSSID, SSID, or HESSID, and associate the AP with the BSSID, SSID, or HESSID. In other cases, the UE 115-a may be preconfigured with the WLAN identifier information (e.g., BSSID, SSID, HESSID) by subscription. In some examples, the WLAN identifier may be preconfigured for a specific PLMN, NPN, or both. When the UE 115-a registers with one PLMN or NPN, the UE 115-a may select the corresponding WLAN identifier. In another example, the UE 115-a may be provisioned with the WLAN identifier via a core network using registration or a UCU procedure.

At 820, UE 115-e may transmit an RRC message to the DU 810 indicating a set of selected WLAN identifiers (e.g., AP BBSID, WT address, BSSID). At 825, based on the destination address, the DU 810 may forward the RRC message to the CU 805.

At 830, based on the RRC message, the CU 805 may determine to initiate and configure a dual connectivity mode by adding a WLAN link to the UE 115-e, where the dual connectivity mode may be a duplication or switching operation. The CU 805 may establish a UE context in the WT 405-d based on WLAN identifier information indicated by the UE 115-e. For example, for each bearer, the CU 805 may establish one GTP-U tunnel between the CU 805 and the WT 405-d. Additionally or alternatively, for a SRB, each RRC message may be carried in a control plane message on the interface of the WT 405-d and the CU 805. In some aspects, the CU 805 may configure dual connectivity mode (e.g., duplication, switching) to the UE 115-e on a per-bearer basis. Additionally, if the CU 805 changes the WT 405-d (or an AP), the CU 805 may include a new WT or AP identifier within a configuration for each bearer. In some cases, if a new AP or WT is configured to the UE 115-e, the UE 115-e may associate with the configured AP or WT.

At 835, the CU 805 may transmit an indication of a WT addition, corresponding to the UE 115-e, to the WT 405-d (e.g., via XwAP). Additionally, at 840, the CU 805 may transmit an RRC reconfiguration with the WT configuration to the DU 810 to support dual connectivity mode (e.g., duplication, switching) to the UE 115-e on a per-bearer basis. Accordingly, at 845, the DU may transmit the RRC reconfiguration with an associated WT configuration to the UE 115-e. In some examples, if the CU 805 changes the WT or AP, then the CU 805 may include an identifier associated with the changes in the WT or AP.

Optionally, at 850, the UE 115-e may be associated with the configured WT or AP with the identifiers provided by the CU 805. Based on the aforementioned operations, the UE 115-e may perform dual connectivity operations via the WT, the DU, the CU, or a combination thereof. For example, at 855, the UE 115-e may communicate using dual connectivity communications based on the configuration provided by the CU 805.

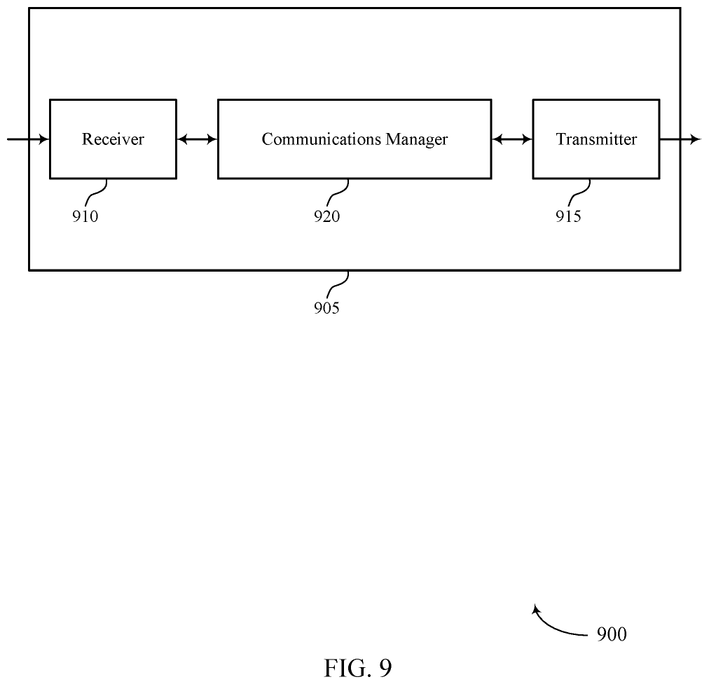

FIG. 9 shows a block diagram 900 of a device 905 that supports connection establishment and dual connectivity communications over a WLAN in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to connection establishment and dual connectivity communications over a WLAN). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to connection establishment and dual connectivity communications over a WLAN). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of connection establishment and dual connectivity communications over a WLAN as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication in accordance with examples as disclosed herein. For example, the communications manager 920 may be configured as or otherwise support a means for transmitting, by a UE, a first packet to a node that is associated with a first RAT including a WLAN, where the first packet includes a first control message requesting establishment of a connection with a network node. The communications manager 920 may be configured as or otherwise support a means for receiving, from the node, a second packet in response to the first control message, where the second packet includes a second control message for establishing the connection between the UE and the network node. The communications manager 920 may be configured as or otherwise support a means for establishing the connection with the network node over a communication link associated with the first RAT based on the second control message.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced processing, reduced power consumption, more efficient utilization of communication resources by leveraging a second RAT to establish communications with a first RAT. Additionally, aspects of the disclosure may provide for further reduced processing and power consumption by enabling link addition or modification associated with the first RAT.

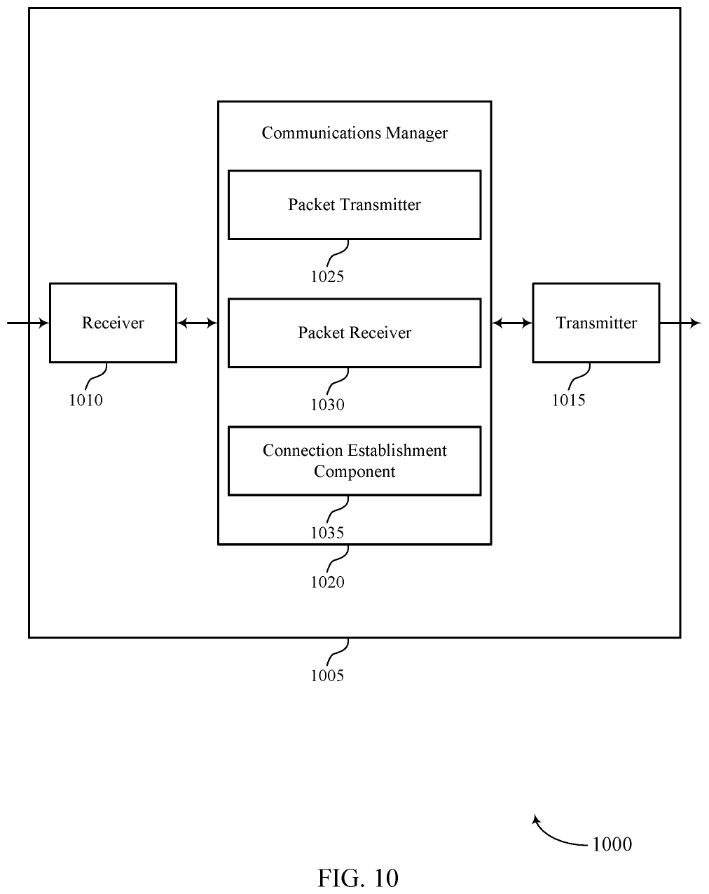

FIG. 10 shows a block diagram 1000 of a device 1005 that supports connection establishment and dual connectivity communications over a WLAN in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to connection establishment and dual connectivity communications over a WLAN). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to connection establishment and dual connectivity communications over a WLAN). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of connection establishment and dual connectivity communications over a WLAN as described herein. For example, the communications manager 1020 may include a packet transmitter 1025, a packet receiver 1030, a connection establishment component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication in accordance with examples as disclosed herein. The packet transmitter 1025 may be configured as or otherwise support a means for transmitting, by a UE, a first packet to a node that is associated with a first RAT including a WLAN, where the first packet includes a first control message requesting establishment of a connection with a network node. The packet receiver 1030 may be configured as or otherwise support a means for receiving, from the node, a second packet in response to the first control message, where the second packet includes a second control message for establishing the connection between the UE and the network node. The connection establishment component 1035 may be configured as or otherwise support a means for establishing the connection with the network node over a communication link associated with the first RAT based on the second control message.

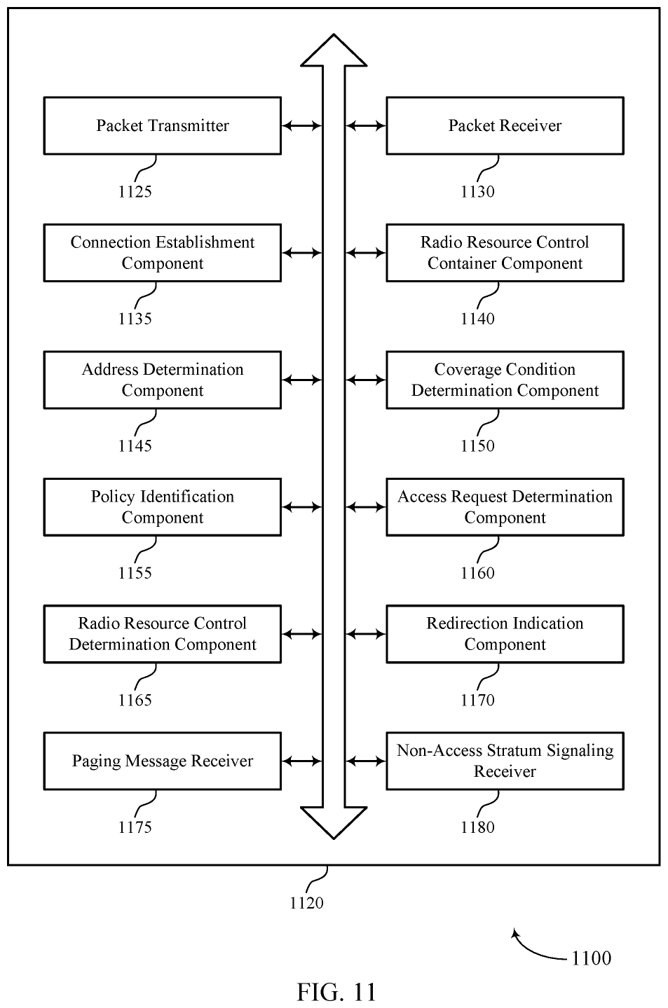

FIG. 11 shows a block diagram 1100 of a communications manager 1120 that supports connection establishment and dual connectivity communications over a WLAN in accordance with aspects of the present disclosure. The communications manager 1120 may be an example of aspects of a communications manager 920, a communications manager 1020, or both, as described herein. The communications manager 1120, or various components thereof, may be an example of means for performing various aspects of connection establishment and dual connectivity communications over a WLAN as described herein. For example, the communications manager 1120 may include a packet transmitter 1125, a packet receiver 1130, a connection establishment component 1135, a radio resource control container component 1140, an address determination component 1145, a coverage condition determination component 1150, a policy identification component 1155, an access request determination component 1160, a radio resource control determination component 1165, a redirection indication component 1170, a paging message receiver 1175, a non-access stratum signaling receiver 1180, or any combination thereof. Each of these components may communicate, directly or indirectly, with one another (e.g., via one or more buses).

The communications manager 1120 may support wireless communication in accordance with examples as disclosed herein. The packet transmitter 1125 may be configured as or otherwise support a means for transmitting, by a UE, a first packet to a node that is associated with a first RAT including a WLAN, where the first packet includes a first control message requesting establishment of a connection with a network node. The packet receiver 1130 may be configured as or otherwise support a means for receiving, from the node, a second packet in response to the first control message, where the second packet includes a second control message for establishing the connection between the UE and the network node. The connection establishment component 1135 may be configured as or otherwise support a means for establishing the connection with the network node over a communication link associated with the first RAT based on the second control message.

In some examples, the packet transmitter 1125 may be configured as or otherwise support a means for transmitting, to the node, a third packet including a third control message, where the connection with the network node is established over the communication link based on the third control message. In some examples, the third control message includes an RRC setup complete message (e.g., RRCSetupComplete).

In some examples, the radio resource control container component 1140 may be configured as or otherwise support a means for encapsulating the first control message in an RRC container, where the first packet includes the RRC container.

In some examples, to support transmitting the first packet to the node, the address determination component 1145 may be configured as or otherwise support a means for determining an address of the node. In some examples, to support transmitting the first packet to the node, the packet transmitter 1125 may be configured as or otherwise support a means for transmitting the first packet having an address field that includes a destination address including the address of the node. In some examples, the address of the node includes a MAC address, or an IP address, or any combination thereof.

In some examples, to support transmitting the first packet to the node, the address determination component 1145 may be configured as or otherwise support a means for determining an address of the network node. In some examples, to support transmitting the first packet to the node, the packet transmitter 1125 may be configured as or otherwise support a means for transmitting the first packet having an address field that includes a destination address including the address of the network node. In some examples, the address of the network node includes a MAC address, or an IP address, or any combination thereof.

In some examples, to support transmitting the first packet to the node, the coverage condition determination component 1150 may be configured as or otherwise support a means for determining that one or more coverage conditions have been satisfied, where the one or more coverage conditions include the UE being outside a coverage of a second RAT associated with the network node, or the coverage of the second RAT satisfying a threshold, or a signal quality of the first RAT being greater than a signal quality of the second RAT, or any combination thereof. In some examples, to support transmitting the first packet to the node, the packet transmitter 1125 may be configured as or otherwise support a means for transmitting the first packet including the first control message based on determining that the one or more coverage conditions have been satisfied.

In some examples, to support transmitting the first packet to the node, the policy identification component 1155 may be configured as or otherwise support a means for identifying policy information configuring the UE to transmit the first packet to the node, the policy information being configured per service, or per cell type, or per application, or per network slice, or any combination thereof. In some examples, to support transmitting the first packet to the node, the packet transmitter 1125 may be configured as or otherwise support a means for transmitting the first packet including the first control message based on the policy information.

In some examples, the non-access stratum signaling receiver 1180 may be configured as or otherwise support a means for receiving non-access stratum signaling configuring the policy information, where the policy information is identified based on the non-access stratum signaling. In some examples, the policy information is preconfigured for the UE based on one or more subscriptions.

In some examples, to support transmitting the first packet to the node, the access request determination component 1160 may be configured as or otherwise support a means for determining that an access request transmitted to the network node has failed based on a random access failure, or access control barring, or a barred cell, or any combination thereof. In some examples, to support transmitting the first packet to the node, the packet transmitter 1125 may be configured as or otherwise support a means for transmitting the first packet including the first control message based on the failed access request.

In some examples, to support transmitting the first packet to the node, the radio resource control determination component 1165 may be configured as or otherwise support a means for determining that an RRC connection with the network node has been rejected. In some examples, to support transmitting the first packet to the node, the packet transmitter 1125 may be configured as or otherwise support a means for transmitting the first packet including the first control message based on the rejected RRC connection.

In some examples, to support transmitting the first packet to the node, the redirection indication component 1170 may be configured as or otherwise support a means for receiving an redirection indication from the network node, the redirection indication including an indication for the UE to request the establishment of the connection with the network node over the communication link. In some examples, to support transmitting the first packet to the node, the packet transmitter 1125 may be configured as or otherwise support a means for transmitting the first packet including the first control message based on the redirection indication.

In some examples, to support transmitting the first packet to the node, the paging message receiver 1175 may be configured as or otherwise support a means for receiving, from the node, a paging message including an indication to request the establishment of the connection with the network node over the communication link. In some examples, to support transmitting the first packet to the node, the packet transmitter 1125 may be configured as or otherwise support a means for transmitting the first packet including the first control message based on the received paging message.

In some examples, the first control message includes an RRC setup request message (e.g., RRCSetupRequest) or an RRC resume request message (e.g., RRCResumeRequest). In some examples, the second control message includes an RRC setup message (e.g., RRCSetup).

In some examples, the UE is configured to support communications via the first RAT and a second RAT different from the first RAT. In some examples, the second RAT includes a NR RAT. In some examples, the network node includes a CU. In some examples, the node includes an AP, or a WT, or any combination thereof.

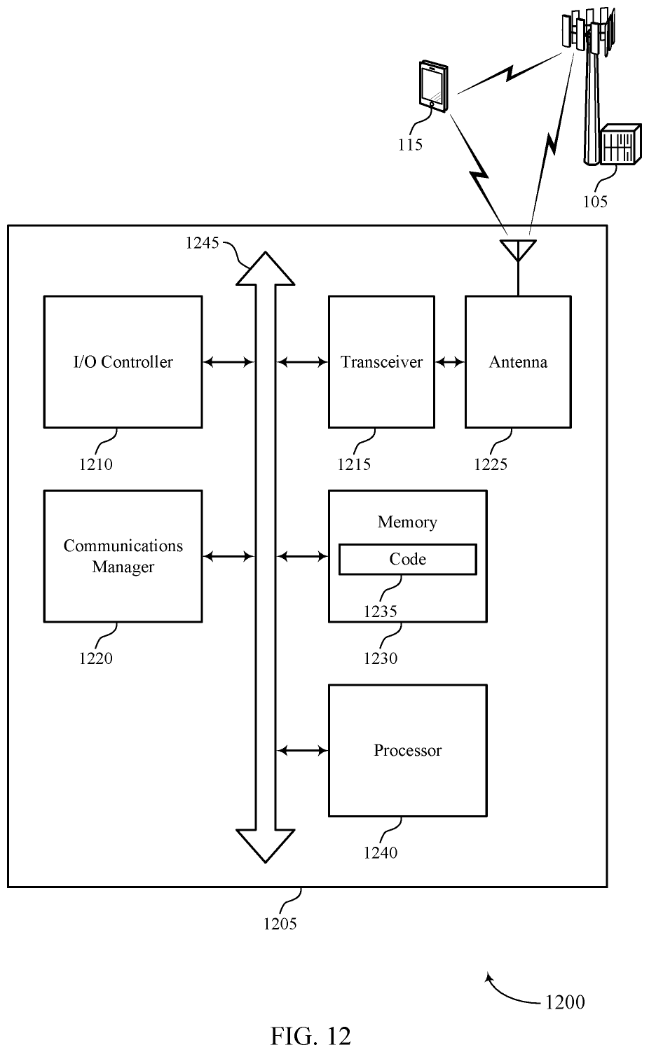

FIG. 12 shows a diagram of a system 1200 including a device 1205 that supports connection establishment and dual connectivity communications over a WLAN in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting connection establishment and dual connectivity communications over a WLAN). For example, the device 1205 or a component of the device 1205 may include a processor 1240 and memory 1230 coupled to the processor 1240, the processor 1240 and memory 1230 configured to perform various functions described herein.

The communications manager 1220 may support wireless communication in accordance with examples as disclosed herein. For example, the communications manager 1220 may be configured as or otherwise support a means for transmitting, by a UE, a first packet to a node that is associated with a first RAT including a WLAN, where the first packet includes a first control message requesting establishment of a connection with a network node. The communications manager 1220 may be configured as or otherwise support a means for receiving, from the node, a second packet in response to the first control message, where the second packet includes a second control message for establishing the connection between the UE and the network node. The communications manager 1220 may be configured as or otherwise support a means for establishing the connection with the network node over a communication link associated with the first RAT based on the second control message.

By including or configuring the communications manager 1220 in accordance with examples as described herein, the device 1205 may support techniques for improved communication reliability, reduced latency, improved user experience related to reduced processing, more efficient utilization of communication resources, improved coordination between devices, longer battery life, reduced signaling overhead by leveraging a second RAT to establish communications with a first RAT. Additionally, aspects of the disclosure may provide for further reduced processing and power consumption by enabling link addition or modification associated with the first RAT.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of connection establishment and dual connectivity communications over a WLAN as described herein, or the processor 1240 and the memory 1230 may be otherwise configured to perform or support such operations.

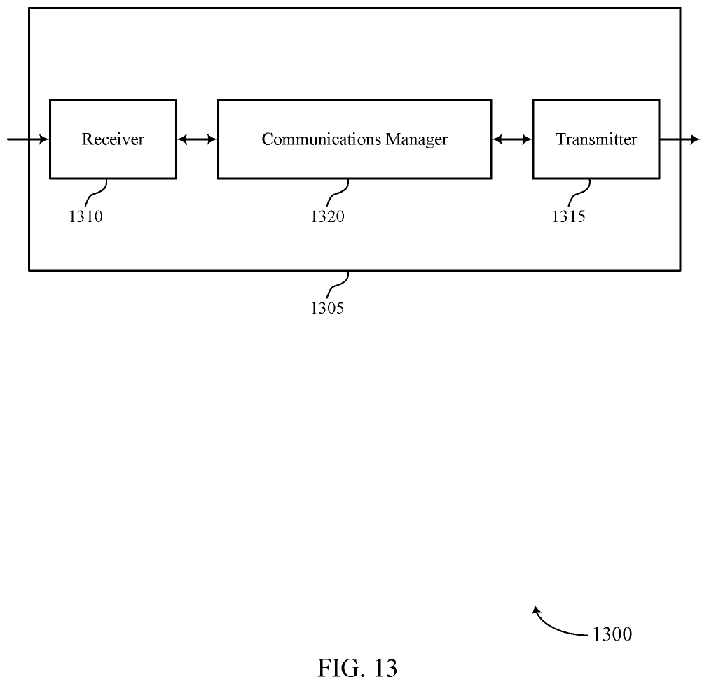

FIG. 13 shows a block diagram 1300 of a device 1305 that supports connection establishment and dual connectivity communications over a WLAN in accordance with aspects of the present disclosure. The device 1305 may be an example of aspects of a base station 105, or a network node, or a CU, or a DU, or any combination thereof, as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to connection establishment and dual connectivity communications over a WLAN). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to connection establishment and dual connectivity communications over a WLAN). In some examples, the transmitter 1315 may be co-located with a receiver 1310 in a transceiver module. The transmitter 1315 may utilize a single antenna or a set of multiple antennas.

The communications manager 1320, the receiver 1310, the transmitter 1315, or various combinations thereof or various components thereof may be examples of means for performing various aspects of connection establishment and dual connectivity communications over a WLAN as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1320 may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication in accordance with examples as disclosed herein. For example, the communications manager 1320 may be configured as or otherwise support a means for receiving, by a network node associated with a first RAT, a first packet from a node associated with a second RAT, the second RAT including a WLAN, where the first packet includes a first control message from a UE configured for communications via the first RAT and the second RAT. The communications manager 1320 may be configured as or otherwise support a means for transmitting, to the node associated with the second RAT, a second packet including a second control message for establishing a connection between the network node and the UE over a communication link associated with the second RAT based on decoding the first control message.

By including or configuring the communications manager 1320 in accordance with examples as described herein, the device 1305 (e.g., a processor controlling or otherwise coupled to the receiver 1310, the transmitter 1315, the communications manager 1320, or a combination thereof) may support techniques for reduced processing, reduced power consumption, more efficient utilization of communication resources by leveraging a second RAT to establish communications with a first RAT. Additionally, aspects of the disclosure may provide for further reduced processing and power consumption by enabling link addition or modification associated with the first RAT.

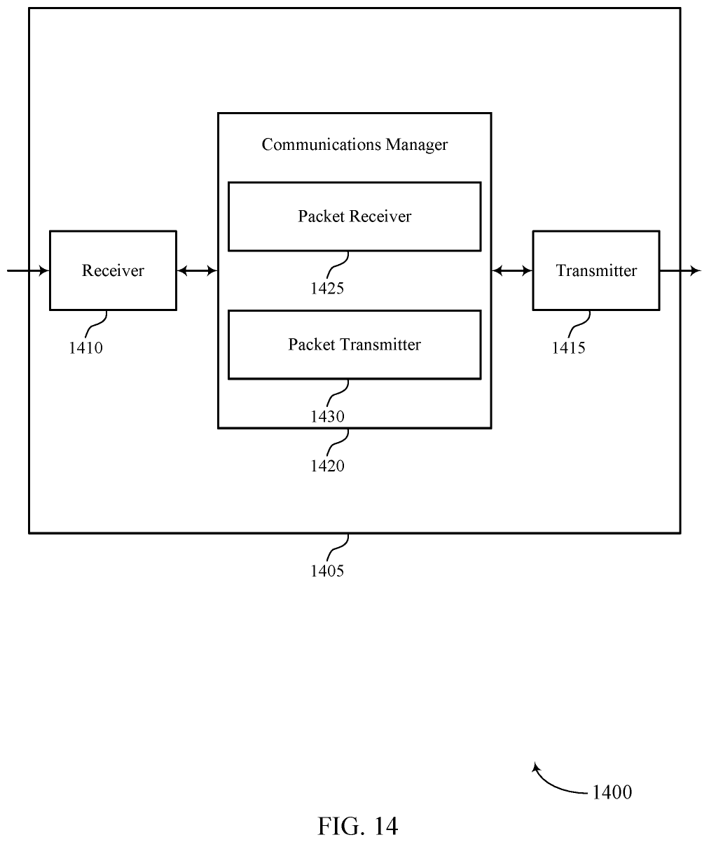

FIG. 14 shows a block diagram 1400 of a device 1405 that supports connection establishment and dual connectivity communications over a WLAN in accordance with aspects of the present disclosure. The device 1405 may be an example of aspects of a device 1305 or a base station 105, a network node, a DU, a CU, or any combination thereof, as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to connection establishment and dual connectivity communications over a WLAN). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to connection establishment and dual connectivity communications over a WLAN). In some examples, the transmitter 1415 may be co-located with a receiver 1410 in a transceiver module. The transmitter 1415 may utilize a single antenna or a set of multiple antennas.

The device 1405, or various components thereof, may be an example of means for performing various aspects of connection establishment and dual connectivity communications over a WLAN as described herein. For example, the communications manager 1420 may include a packet receiver 1425 a packet transmitter 1430, or any combination thereof. The communications manager 1420 may be an example of aspects of a communications manager 1320 as described herein. In some examples, the communications manager 1420, or various components thereof, may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communication in accordance with examples as disclosed herein. The packet receiver 1425 may be configured as or otherwise support a means for receiving, by a network node associated with a first RAT, a first packet from a node associated with a second RAT, the second RAT including a WLAN, where the first packet includes a first control message from a UE configured for communications via the first RAT and the second RAT. The packet transmitter 1430 may be configured as or otherwise support a means for transmitting, to the node associated with the second RAT, a second packet including a second control message for establishing a connection between the network node and the UE over a communication link associated with the second RAT based on decoding the first control message.

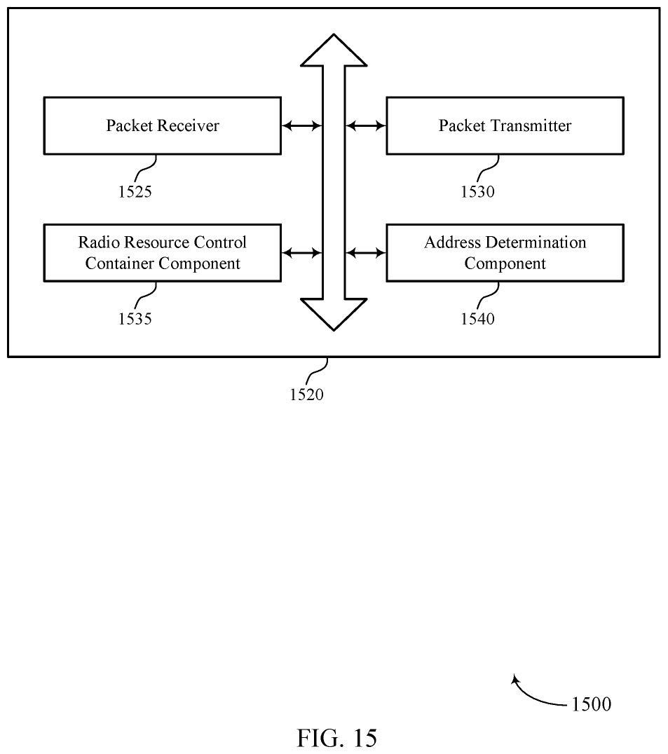

FIG. 15 shows a block diagram 1500 of a communications manager 1520 that supports connection establishment and dual connectivity communications over a WLAN in accordance with aspects of the present disclosure. The communications manager 1520 may be an example of aspects of a communications manager 1320, a communications manager 1420, or both, as described herein. The communications manager 1520, or various components thereof, may be an example of means for performing various aspects of connection establishment and dual connectivity communications over a WLAN as described herein. For example, the communications manager 1520 may include a packet receiver 1525, a packet transmitter 1530, a radio resource control container component 1535, an address determination component 1540, or any combination thereof. Each of these components may communicate, directly or indirectly, with one another (e.g., via one or more buses).

The communications manager 1520 may support wireless communication in accordance with examples as disclosed herein. The packet receiver 1525 may be configured as or otherwise support a means for receiving, by a network node associated with a first RAT, a first packet from a node associated with a second RAT, the second RAT including a WLAN, where the first packet includes a first control message from a UE configured for communications via the first RAT and the second RAT. The packet transmitter 1530 may be configured as or otherwise support a means for transmitting, to the node associated with the second RAT, a second packet including a second control message for establishing a connection between the network node and the UE over a communication link associated with the second RAT based on decoding the first control message.

In some examples, the first packet is received via a user plane, and the packet receiver 1525 may be configured as or otherwise support a means for receiving the first packet via a GTP-U tunnel from the node, where the first packet includes a TEID allocated to the UE.

In some examples, to support transmitting the second packet including the second control message, the packet transmitter 1530 may be configured as or otherwise support a means for transmitting the second packet via the GTP-U tunnel to the node, where a destination TEID of the second packet includes the TEID allocated to the UE.

In some examples, the radio resource control container component 1535 may be configured as or otherwise support a means for encapsulating the second control message in an RRC container, where the second packet includes the RRC container.

In some examples, the packet receiver 1525 may be configured as or otherwise support a means for receiving, from the node, a third packet including a third control message, the third control message including a radio resource setup complete message, where the connection between the network node and the UE is established over the communication link based on the third control message.

In some examples, to support transmitting the second packet including the second control message, the address determination component 1540 may be configured as or otherwise support a means for determining an address of the UE, the address including a MAC address, or an IP address, or a UE association identifier, or any combination thereof. In some examples, to support transmitting the second packet including the second control message, the packet transmitter 1530 may be configured as or otherwise support a means for transmitting the second packet including the address of the UE.

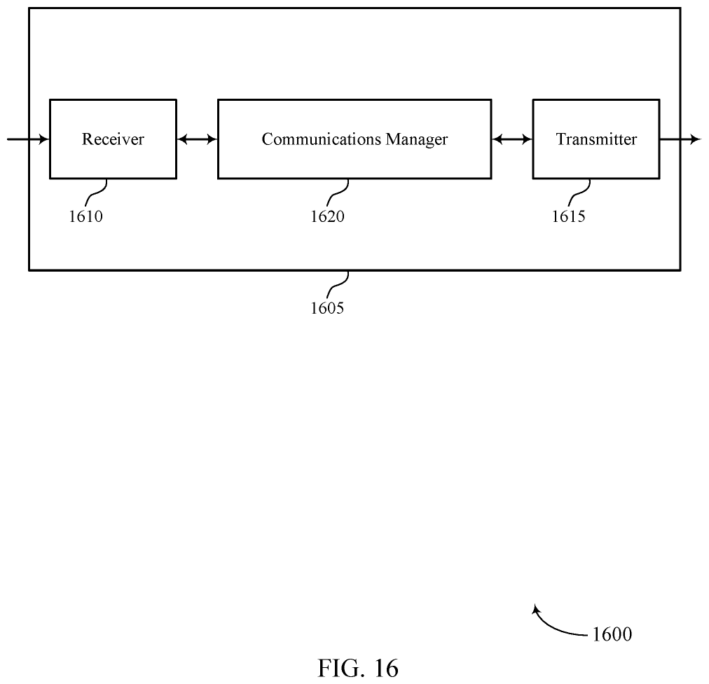

FIG. 16 shows a block diagram 1600 of a device 1605 that supports connection establishment and dual connectivity communications over a WLAN in accordance with aspects of the present disclosure. The device 1605 may be an example of aspects of a node (e.g., an AP, a WT) as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to connection establishment and dual connectivity communications over a WLAN). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to connection establishment and dual connectivity communications over a WLAN). In some examples, the transmitter 1615 may be co-located with a receiver 1610 in a transceiver module. The transmitter 1615 may utilize a single antenna or a set of multiple antennas.

The communications manager 1620, the receiver 1610, the transmitter 1615, or various combinations thereof or various components thereof may be examples of means for performing various aspects of connection establishment and dual connectivity communications over a WLAN as described herein. For example, the communications manager 1620, the receiver 1610, the transmitter 1615, or various combinations or components thereof may support a method for performing one or more of the functions described herein.

In some examples, the communications manager 1620, the receiver 1610, the transmitter 1615, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1620, the receiver 1610, the transmitter 1615, or various combinations or components thereof may be implemented in code (e.g., as communications management software or firmware) executed by a processor. If implemented in code executed by a processor, the functions of the communications manager 1620, the receiver 1610, the transmitter 1615, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1620 may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support wireless communication in accordance with examples as disclosed herein. For example, the communications manager 1620 may be configured as or otherwise support a means for receiving, by a node associated with a first RAT, a first packet from a UE configured for communications via the first RAT and a second RAT, the first RAT including a WLAN, where the first packet includes a first control message requesting establishment of a connection between the UE and a network node associated with the second RAT. The communications manager 1620 may be configured as or otherwise support a means for transmitting, to the network node associated with the second RAT, a second packet including the first control message for establishing the connection between UE and the network node based on receiving the first packet.

By including or configuring the communications manager 1620 in accordance with examples as described herein, the device 1605 (e.g., a processor controlling or otherwise coupled to the receiver 1610, the transmitter 1615, the communications manager 1620, or a combination thereof) may support techniques for reduced processing, reduced power consumption, more efficient utilization of communication resources by leveraging a second RAT to establish communications with a first RAT. Additionally, aspects of the disclosure may provide for further reduced processing and power consumption by enabling link addition or modification associated with the first RAT.

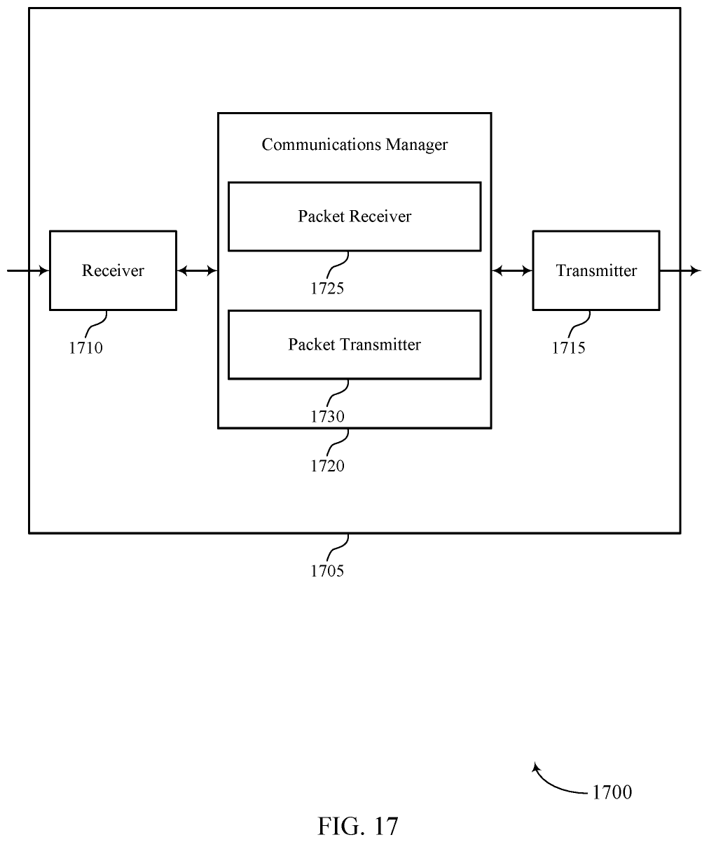

FIG. 17 shows a block diagram 1700 of a device 1705 that supports connection establishment and dual connectivity communications over a WLAN in accordance with aspects of the present disclosure. The device 1705 may be an example of aspects of a device 1605 or a node (e.g., an AP, a WT) as described herein. The device 1705 may include a receiver 1710, a transmitter 1715, and a communications manager 1720. The device 1705 may also include a processor. Each of these components may be in communication with one another (e.g., via one or more buses).

The receiver 1710 may provide a means for receiving information such as packets, user data, control information, or any combination thereof associated with various information channels (e.g., control channels, data channels, information channels related to connection establishment and dual connectivity communications over a WLAN). Information may be passed on to other components of the device 1705. The receiver 1710 may utilize a single antenna or a set of multiple antennas.

The transmitter 1715 may provide a means for transmitting signals generated by other components of the device 1705. For example, the transmitter 1715 may transmit information such as packets, user data, control information, or any combination thereof associated with various information channels (e.g., control channels, data channels, information channels related to connection establishment and dual connectivity communications over a WLAN). In some examples, the transmitter 1715 may be co-located with a receiver 1710 in a transceiver module. The transmitter 1715 may utilize a single antenna or a set of multiple antennas.

The device 1705, or various components thereof, may be an example of means for performing various aspects of connection establishment and dual connectivity communications over a WLAN as described herein. For example, the communications manager 1720 may include a packet receiver 1725 a packet transmitter 1730, or any combination thereof. The communications manager 1720 may be an example of aspects of a communications manager 1620 as described herein. In some examples, the communications manager 1720, or various components thereof, may be configured to perform various operations (e.g., receiving, monitoring, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to receive information, transmit information, or perform various other operations as described herein.

The communications manager 1720 may support wireless communication in accordance with examples as disclosed herein. The packet receiver 1725 may be configured as or otherwise support a means for receiving, at a node associated with a first RAT, a first packet from a UE configured for communications via the first RAT and a second RAT, the first RAT including a WLAN, where the first packet includes a first control message requesting establishment of a connection between the UE and a network node (e.g., a CU) associated with the second RAT. The packet transmitter 1730 may be configured as or otherwise support a means for transmitting, to the network node associated with the second RAT, a second packet including the first control message for establishing the connection between UE and the network node based on receiving the first packet.

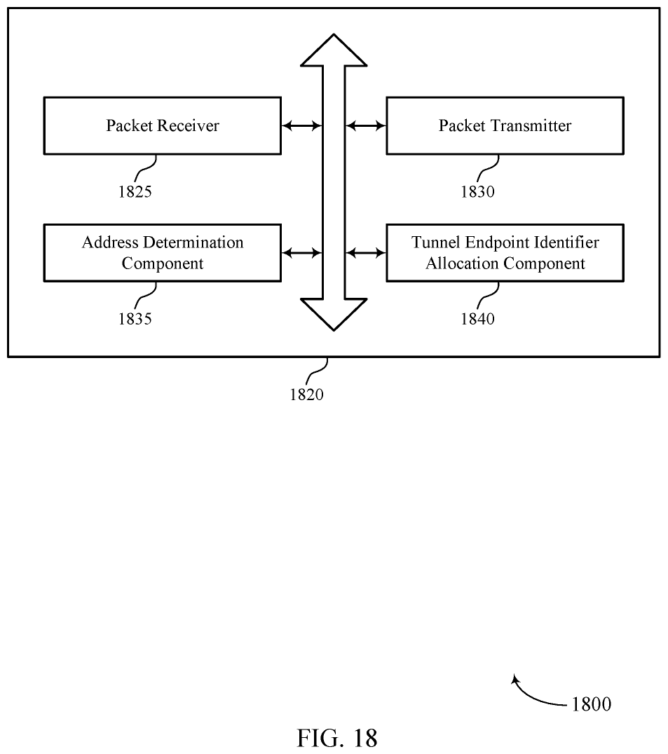

FIG. 18 shows a block diagram 1800 of a communications manager 1820 that supports connection establishment and dual connectivity communications over a WLAN in accordance with aspects of the present disclosure. The communications manager 1820 may be an example of aspects of a communications manager 1620, a communications manager 1720, or both, as described herein. The communications manager 1820, or various components thereof, may be an example of means for performing various aspects of connection establishment and dual connectivity communications over a WLAN as described herein. For example, the communications manager 1820 may include a packet receiver 1825, a packet transmitter 1830, an address determination component 1835, a tunnel endpoint identifier allocation component 1840, or any combination thereof. Each of these components may communicate, directly or indirectly, with one another (e.g., via one or more buses).

The communications manager 1820 may support wireless communication in accordance with examples as disclosed herein. The packet receiver 1825 may be configured as or otherwise support a means for receiving, by a node associated with a first RAT, a first packet from a UE configured for communications via the first RAT and a second RAT, the first RAT including a WLAN, where the first packet includes a first control message requesting establishment of a connection between the UE and a network node associated with the second RAT. The packet transmitter 1830 may be configured as or otherwise support a means for transmitting, to the network node associated with the second RAT, a second packet including the first control message for establishing the connection between UE and the network node based on receiving the first packet.

In some examples, to support transmitting the second packet including the first control message, the address determination component 1835 may be configured as or otherwise support a means for determining an address of the UE, the address including a MAC address, or an IP address, or a UE association identifier, or any combination thereof. In some examples, to support transmitting the second packet including the first control message, the packet transmitter 1830 may be configured as or otherwise support a means for transmitting the second packet including the address of the UE.

In some examples, the second packet is transmitted via a user plane, and the tunnel endpoint identifier allocation component 1840 may be configured as or otherwise support a means for allocating a TEID to the UE. In some examples, the second packet is transmitted via a user plane, and the packet transmitter 1830 may be configured as or otherwise support a means for transmitting the second packet via a GTP-U tunnel to the network node associated with the second RAT, where the second packet includes the TEID allocated to the UE.

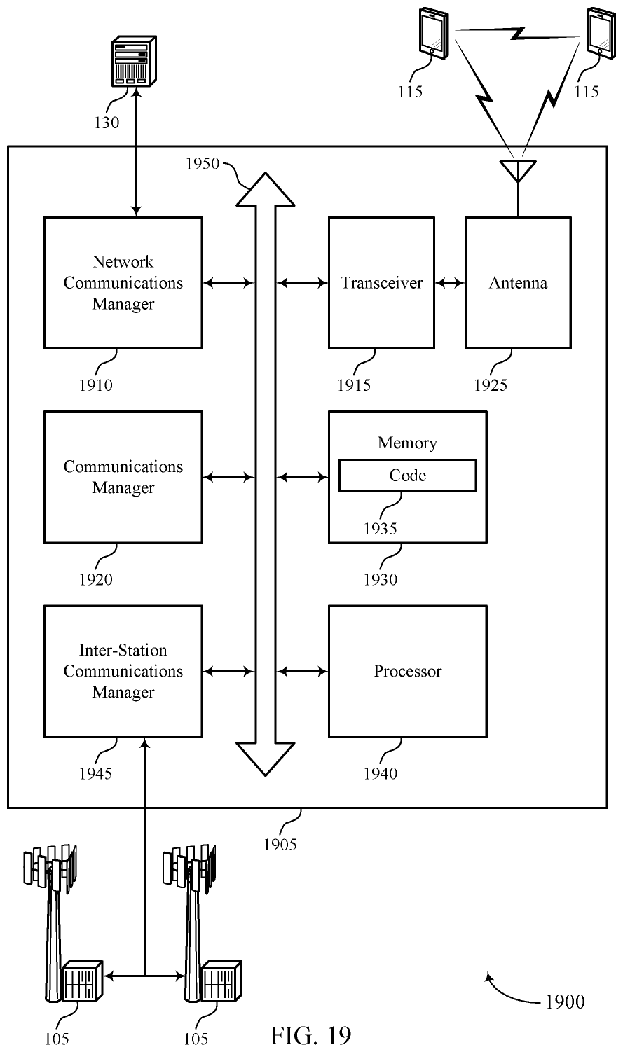

FIG. 19 shows a diagram of a system 1900 including a device 1905 that supports connection establishment and dual connectivity communications over a WLAN in accordance with aspects of the present disclosure. The device 1905 may be an example of or include the components of a device 1305, a device 1405, a base station 105, or a network node (e.g., a CU, a DU) as described herein. Additionally or alternatively, the device 1905 may be an example of or include the components of a device 1605, a device 1705, or a node (e.g., a WT, an AP) described herein. The device 1905 may communicate wirelessly with one or more base stations 105, UEs 115, or any combination thereof. The device 1905 may include components for bi-directional voice and data communications including components for transmitting and receiving communications, such as a communications manager 1920, a network communications manager 1910, a transceiver 1915, an antenna 1925, a memory 1930, code 1935, a processor 1940, and an inter-station communications manager 1945. These components may be in electronic communication or otherwise coupled (e.g., operatively, communicatively, functionally, electronically, electrically) via one or more buses (e.g., a bus 1950).

The network communications manager 1910 may manage communications with a core network 130 (e.g., via one or more wired backhaul links). For example, the network communications manager 1910 may manage the transfer of data communications for client devices, such as one or more UEs 115.

In some cases, the device 1905 may include a single antenna 1925. However, in some other cases the device 1905 may have more than one antenna 1925, which may be capable of concurrently transmitting or receiving multiple wireless transmissions. The transceiver 1915 may communicate bi-directionally, via the one or more antennas 1925, wired, or wireless links as described herein. For example, the transceiver 1915 may represent a wireless transceiver and may communicate bi-directionally with another wireless transceiver. The transceiver 1915 may also include a modem to modulate the packets, to provide the modulated packets to one or more antennas 1925 for transmission, and to demodulate packets received from the one or more antennas 1925. The transceiver 1915, or the transceiver 1915 and one or more antennas 1925, may be an example of a transmitter 1315, a transmitter 1415, a receiver 1310, a receiver 1410, or any combination thereof or component thereof, as described herein. Similarly, the transceiver 1915, or the transceiver 1915 and one or more antennas 1925, may be an example of a transmitter 1615, a transmitter 1715, a receiver 1610, a receiver 1710, or any combination thereof or component thereof, as described herein.

The memory 1930 may include RAM and ROM. The memory 1930 may store computer-readable, computer-executable code 1935 including instructions that, when executed by the processor 1940, cause the device 1905 to perform various functions described herein. The code 1935 may be stored in a non-transitory computer-readable medium such as system memory or another type of memory. In some cases, the code 1935 may not be directly executable by the processor 1940 but may cause a computer (e.g., when compiled and executed) to perform functions described herein. In some cases, the memory 1930 may contain, among other things, a BIOS which may control basic hardware or software operation such as the interaction with peripheral components or devices.

The processor 1940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1940 may be configured to operate a memory array using a memory controller. In some other cases, a memory controller may be integrated into the processor 1940. The processor 1940 may be configured to execute computer-readable instructions stored in a memory (e.g., the memory 1930) to cause the device 1905 to perform various functions (e.g., functions or tasks supporting connection establishment and dual connectivity communications over a WLAN). For example, the device 1905 or a component of the device 1905 may include a processor 1940 and memory 1930 coupled to the processor 1940, the processor 1940 and memory 1930 configured to perform various functions described herein.

The inter-station communications manager 1945 may manage communications with other base stations 105, and may include a controller or scheduler for controlling communications with UEs 115 in cooperation with other base stations 105. For example, the inter-station communications manager 1945 may coordinate scheduling for transmissions to UEs 115 for various interference mitigation techniques such as beamforming or joint transmission. In some examples, the inter-station communications manager 1945 may provide an X2 interface within an LTE/LTE-A wireless communications network technology to provide communication between base stations 105.

The communications manager 1920 may support wireless communication in accordance with examples as disclosed herein. For example, the communications manager 1920 may be configured as or otherwise support a means for receiving, by a network node associated with a first RAT, a first packet from a node associated with a second RAT, the second RAT including a WLAN, where the first packet includes a first control message from a UE configured for communications via the first RAT and the second RAT. The communications manager 1920 may be configured as or otherwise support a means for transmitting, to the node associated with the second RAT, a second packet including a second control message for establishing a connection between the network node and the UE over a communication link associated with the second RAT based on decoding the first control message.

Additionally or alternatively, the communications manager 1920 may be configured as or otherwise support a means for receiving, by a node associated with a first RAT, a first packet from a UE configured for communications via the first RAT and a second RAT, the first RAT including a WLAN, where the first packet includes a first control message requesting establishment of a connection between the UE and a network node associated with the second RAT. The communications manager 1920 may be configured as or otherwise support a means for transmitting, to the network node associated with the second RAT, a second packet including the first control message for establishing the connection between UE and the network node based on receiving the first packet.

By including or configuring the communications manager 1920 in accordance with examples as described herein, the device 1905 may support techniques for improved communication reliability, reduced latency, improved user experience related to reduced processing, more efficient utilization of communication resources, improved coordination between devices, longer battery life, reduced signaling overhead by leveraging a second RAT to establish communications with a first RAT. Additionally, aspects of the disclosure may provide for further reduced processing and power consumption by enabling link addition or modification associated with the first RAT.

In some examples, the communications manager 1920 may be configured to perform various operations (e.g., receiving, monitoring, transmitting) using or otherwise in cooperation with the transceiver 1915, the one or more antennas 1925, or any combination thereof. Although the communications manager 1920 is illustrated as a separate component, in some examples, one or more functions described with reference to the communications manager 1920 may be supported by or performed by the processor 1940, the memory 1930, the code 1935, or any combination thereof. For example, the code 1935 may include instructions executable by the processor 1940 to cause the device 1905 to perform various aspects of connection establishment and dual connectivity communications over a WLAN as described herein, or the processor 1940 and the memory 1930 may be otherwise configured to perform or support such operations.

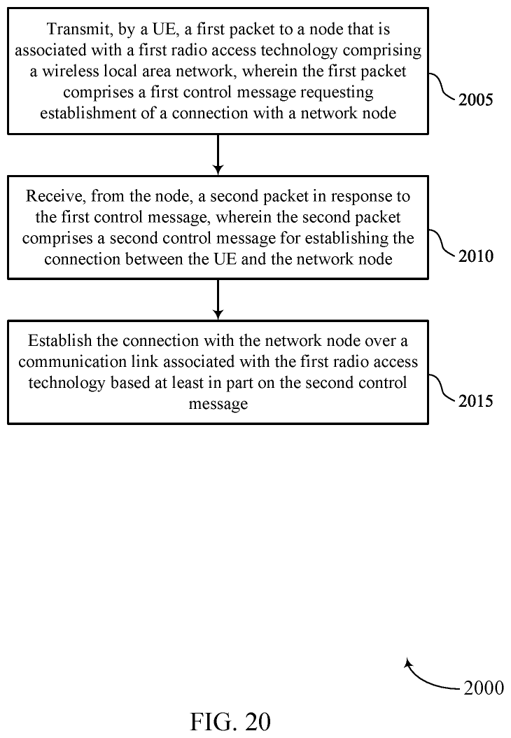

FIG. 20 shows a flowchart illustrating a method 2000 that supports connection establishment and dual connectivity communications over a WLAN in accordance with aspects of the present disclosure. The operations of the method 2000 may be implemented by a UE or its components as described herein. For example, the operations of the method 2000 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 2005, the method may include transmitting, by a UE, a first packet to a node (e.g., an AP, a WT) that is associated with a first RAT including a WLAN, where the first packet includes a first control message (e.g., an RRC message) requesting establishment of a connection with a network node (e.g., a CU associated with a RAN, such as a 5G NR RAN). The operations of 2005 may be performed in accordance with examples as disclosed herein. In some examples, aspects of the operations of 2005 may be performed by a packet transmitter 1125 as described with reference to FIG. 11.

At 2010, the method may include receiving, from the node, a second packet in response to the first control message, where the second packet includes a second control message for establishing the connection between the UE and the network node. The operations of 2010 may be performed in accordance with examples as disclosed herein. In some examples, aspects of the operations of 2010 may be performed by a packet receiver 1130 as described with reference to FIG. 11.

At 2015, the method may include establishing the connection with the network node over a communication link associated with the first RAT based at least in part on the second control message. The operations of 2015 may be performed in accordance with examples as disclosed herein. In some examples, aspects of the operations of 2015 may be performed by a connection establishment component 1135 as described with reference to FIG. 11.

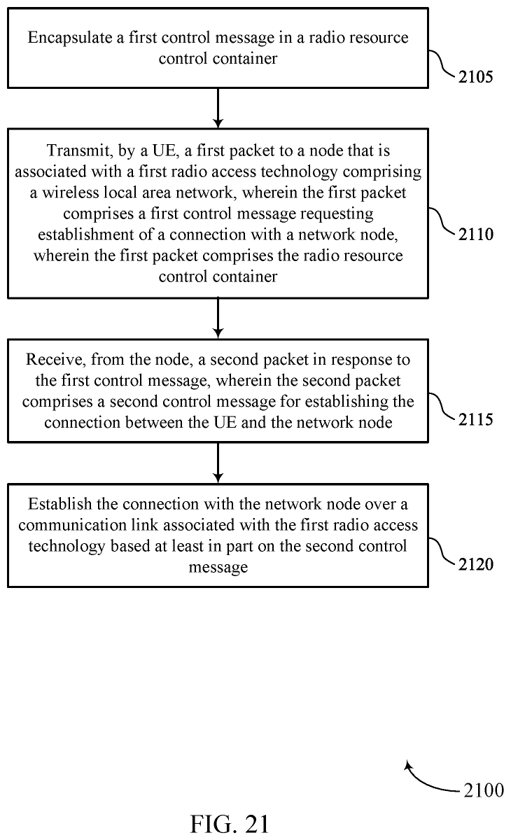

FIG. 21 shows a flowchart illustrating a method 2100 that supports connection establishment and dual connectivity communications over a WLAN in accordance with aspects of the present disclosure. The operations of the method 2100 may be implemented by a UE or its components as described herein. For example, the operations of the method 2100 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 2105, the method may include encapsulating a first control message (e.g., RRCSetupRequest, RRCResumeRequest) in an RRC container. The operations of 2105 may be performed in accordance with examples as disclosed herein. In some examples, aspects of the operations of 2105 may be performed by a radio resource control container component 1140 as described with reference to FIG. 11.

At 2110, the method may include transmitting a first packet to a node (e.g., an AP, a WT) that is associated with a first RAT including a WLAN, where the first packet includes a first control message requesting establishment of a connection with a network node. For example, the first packet includes the RRC container The operations of 2110 may be performed in accordance with examples as disclosed herein. In some examples, aspects of the operations of 2110 may be performed by a packet transmitter 1125 as described with reference to FIG. 11.

At 2115, the method may include receiving, from the node, a second packet in response to the first control message, where the second packet includes a second control message for establishing the connection between the UE and the network node. The operations of 2115 may be performed in accordance with examples as disclosed herein. In some examples, aspects of the operations of 2115 may be performed by a packet receiver 1130 as described with reference to FIG. 11.

At 2120, the method may include establishing the connection with the network node over a communication link associated with the first RAT based at least in part on the second control message. The operations of 2120 may be performed in accordance with examples as disclosed herein. In some examples, aspects of the operations of 2120 may be performed by a connection establishment component 1135 as described with reference to FIG. 11.

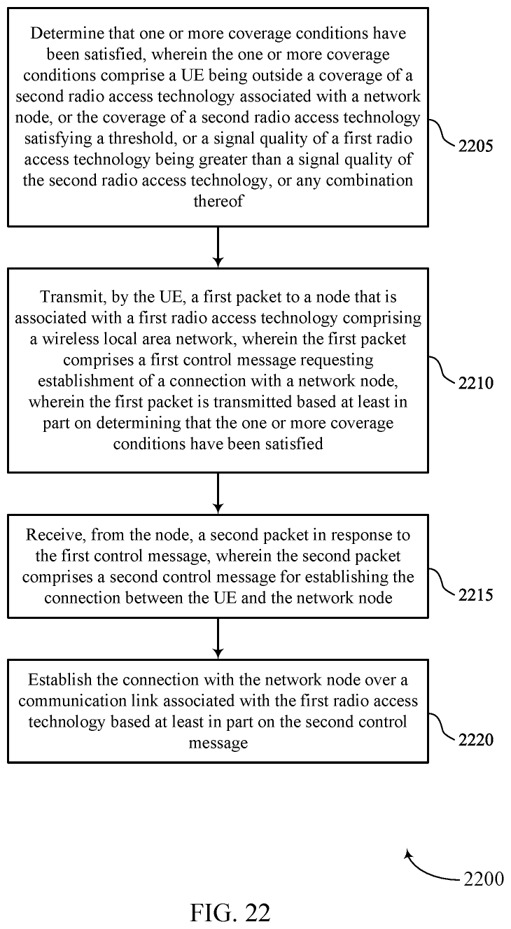

FIG. 22 shows a flowchart illustrating a method 2200 that supports connection establishment and dual connectivity communications over a WLAN in accordance with aspects of the present disclosure. The operations of the method 2200 may be implemented by a UE or its components as described herein. For example, the operations of the method 2200 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 2205, the method may include determining that one or more coverage conditions have been satisfied, where the one or more coverage conditions include the UE being outside a coverage of a second RAT associated with the network node, or the coverage of the second RAT satisfying a threshold, or a signal quality of the first RAT being greater than a signal quality of the second RAT, or any combination thereof. The operations of 2205 may be performed in accordance with examples as disclosed herein. In some examples, aspects of the operations of 2205 may be performed by a coverage condition determination component 1150 as described with reference to FIG. 11.

At 2210, the method may include transmitting, by a UE, a first packet to a node that is associated with a first RAT including a WLAN, where the first packet includes a first control message requesting establishment of a connection with a network node. In some examples, transmitting the first packet including the first control message may be based at least in part on determining that the one or more coverage conditions have been satisfied. The operations of 2210 may be performed in accordance with examples as disclosed herein. In some examples, aspects of the operations of 2210 may be performed by a packet transmitter 1125 as described with reference to FIG. 11.

At 2215, the method may include receiving, from the node, a second packet in response to the first control message, where the second packet includes a second control message for establishing the connection between the UE and the network node. The operations of 2215 may be performed in accordance with examples as disclosed herein. In some examples, aspects of the operations of 2215 may be performed by a packet receiver 1130 as described with reference to FIG. 11.

At 2220, the method may include establishing the connection with the network node over a communication link associated with the first RAT based at least in part on the second control message. The operations of 2220 may be performed in accordance with examples as disclosed herein. In some examples, aspects of the operations of 2220 may be performed by a connection establishment component 1135 as described with reference to FIG. 11.

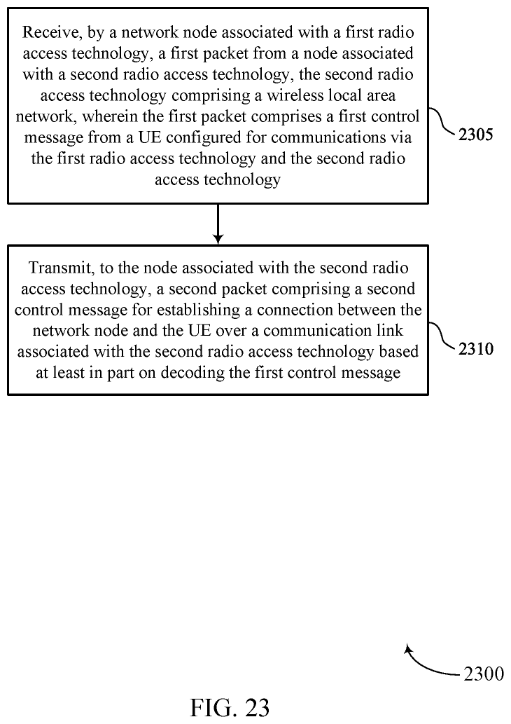

FIG. 23 shows a flowchart illustrating a method 2300 that supports connection establishment and dual connectivity communications over a WLAN in accordance with aspects of the present disclosure. The operations of the method 2300 may be implemented by a base station or a network node (e.g., a CU, a DU) or its components as described herein. For example, the operations of the method 2300 may be performed by a CU as described with reference to FIGS. 1 through 8 and 13 through 19. In some examples, a base station, CU, or DU may execute a set of instructions to control the functional elements of the base station, CU, DU, or any combination thereof, to perform the described functions. Additionally or alternatively, the base station, CU, DU, or any combination thereof, may perform aspects of the described functions using special-purpose hardware.

At 2305, the method may include receiving, by a network node associated with a first RAT, a first packet from a node associated with a second RAT, the second RAT including a WLAN, where the first packet includes a first control message from a UE configured for communications via the first RAT and the second RAT. The operations of 2305 may be performed in accordance with examples as disclosed herein. In some examples, aspects of the operations of 2305 may be performed by a packet receiver 1525 as described with reference to FIG. 15.

At 2310, the method may include transmitting, to the node associated with the second RAT (e.g., an AP, a WT), a second packet including a second control message for establishing a connection between the network node and the ULE over a communication link associated with the second RAT based at least in part on decoding the first control message. The operations of 2310 may be performed in accordance with examples as disclosed herein. In some examples, aspects of the operations of 2310 may be performed by a packet transmitter 1530 as described with reference to FIG. 15.

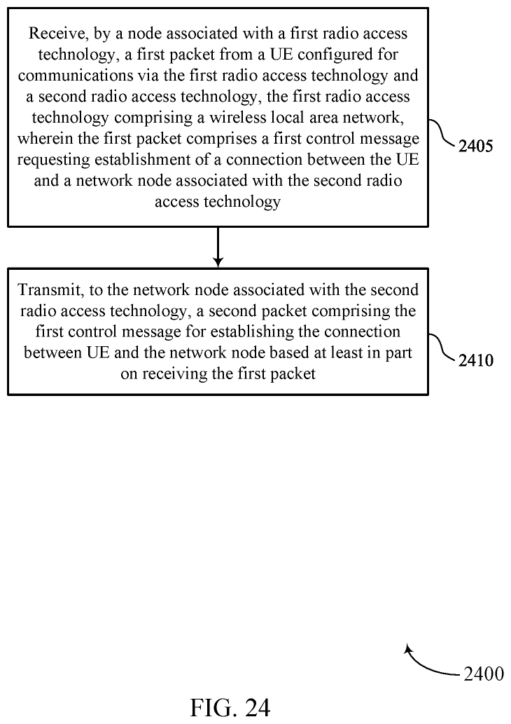

FIG. 24 shows a flowchart illustrating a method 2400 that supports connection establishment and dual connectivity communications over a WLAN in accordance with aspects of the present disclosure. The operations of the method 2400 may be implemented by a node (e.g., an AP, a WT) or its components as described herein. For example, the operations of the method 2400 may be performed by a node as described with reference to FIGS. 1 through 8 and 16 through 18. In some examples, a node may execute a set of instructions to control the functional elements of the node to perform the described functions. Additionally or alternatively, the node may perform aspects of the described functions using special-purpose hardware.

At 2405, the method may include receiving, by a node associated with a first RAT (e.g., an AP associated with WLAN, a WT), a first packet from a UE configured for communications via the first RAT and a second RAT, the first RAT including a WLAN, where the first packet includes a first control message requesting establishment of a connection between the UE and a network node associated with the second RAT. The operations of 2405 may be performed in accordance with examples as disclosed herein. In some examples, aspects of the operations of 2405 may be performed by a packet receiver 1825 as described with reference to FIG. 18.

At 2410, the method may include transmitting, to the network node associated with the second RAT, a second packet including the first control message for establishing the connection between UE and the network node based at least in part on receiving the first packet. The operations of 2410 may be performed in accordance with examples as disclosed herein. In some examples, aspects of the operations of 2410 may be performed by a packet transmitter 1830 as described with reference to FIG. 18.

The following provides an overview of aspects of the present disclosure:
Aspect 1: A method for wireless communication, comprising: transmitting, by a UE, a first packet to a node that is associated with a first radio access technology comprising a wireless local area network, wherein the first packet comprises a first control message requesting establishment of a connection with a network node; receiving, from the node, a second packet in response to the first control message, wherein the second packet comprises a second control message for establishing the connection between the UE and the network node; and establishing the connection with the network node over a communication link associated with the first radio access technology based at least in part on the second control message.
Aspect 2: The method of aspect 1, further comprising: transmitting, to the node, a third packet comprising a third control message, wherein the connection with the network node is established over the communication link based at least in part on the third control message.
Aspect 3: The method of aspect 2, wherein the third control message comprises a radio resource control setup complete message.
Aspect 4: The method of any of aspects 1 through 3, further comprising: encapsulating the first control message in a radio resource control container, wherein the first packet comprises the radio resource control container.
Aspect 5: The method of any of aspects 1 through 4, wherein transmitting the first packet to the node comprises: determining an address of the node; and transmitting the first packet having an address field that includes a destination address comprising the address of the node.
Aspect 6: The method of aspect 5, wherein the address of the node comprises a medium access control (MAC) address, or an Internet protocol (IP) address, or any combination thereof.
Aspect 7: The method of any of aspects 1 through 6, wherein transmitting the first packet to the node comprises: determining an address of the network node; and transmitting the first packet having an address field that includes a destination address comprising the address of the network node.
Aspect 8: The method of aspect 7, wherein the address of the network node comprises a medium access control (MAC) address, or an Internet protocol (IP) address, or any combination thereof.
Aspect 9: The method of any of aspects 1 through 8, wherein transmitting the first packet to the node comprises: determining that one or more coverage conditions have been satisfied, wherein the one or more coverage conditions comprise the UE being outside a coverage of a second radio access technology associated with the network node, or the coverage of the second radio access technology satisfying a threshold, or a signal quality of the first radio access technology being greater than a signal quality of the second radio access technology, or any combination thereof; and transmitting the first packet comprising the first control message based at least in part on determining that the one or more coverage conditions have been satisfied.
Aspect 10: The method of any of aspects 1 through 9, wherein transmitting the first packet to the node comprises: identifying policy information configuring the UE to transmit the first packet to the node, the policy information being configured per service, or per cell type, or per application, or per network slice, or any combination thereof; and transmitting the first packet comprising the first control message based at least in part on the policy information.
Aspect 11: The method of aspect 10, further comprising: receiving non-access stratum signaling configuring the policy information, wherein the policy information is identified based at least in part on the non-access stratum signaling.
Aspect 12: The method of any of aspects 10 through 11, wherein the policy information is preconfigured for the UE based at least in part on one or more subscriptions.
Aspect 13: The method of any of aspects 1 through 12, wherein transmitting the first packet to the node comprises: determining that an access request transmitted to the network node has failed based at least in part on a random access failure, or access control barring, or a barred cell, or any combination thereof, and transmitting the first packet comprising the first control message based at least in part on the failed access request.
Aspect 14: The method of any of aspects 1 through 13, wherein transmitting the first packet to the node comprises: determining that a radio resource control connection with the network node has been rejected; and transmitting the first packet comprising the first control message based at least in part on the rejected radio resource control connection.
Aspect 15: The method of any of aspects 1 through 14, wherein transmitting the first packet to the node comprises: receiving an redirection indication from the network node, the redirection indication comprising an indication for the UE to request the establishment of the connection with the network node over the communication link; and transmitting the first packet comprising the first control message based at least in part on the redirection indication.
Aspect 16: The method of any of aspects 1 through 15, wherein transmitting the first packet to the node comprises: receiving, from the node, a paging message comprising an indication to request the establishment of the connection with the network node over the communication link; and transmitting the first packet comprising the first control message based at least in part on the received paging message.
Aspect 17: The method of any of aspects 1 through 16, wherein the first control message comprises a radio resource control setup request message or a radio resource control resume request message, and the second control message comprises a radio resource control setup message.
Aspect 18: The method of any of aspects 1 through 17, wherein the UE is configured to support communications via the first radio access technology and a second radio access technology.
Aspect 19: The method of aspect 18, wherein the second radio access technology comprises a new radio (NR) radio access technology, and the network node comprises a centralized unit (CU).
Aspect 20: The method of any of aspects 1 through 19, wherein the node comprises an AP, or a wireless local area network termination (WT), or any combination thereof.
Aspect 21: A method for wireless communication, comprising: receiving, by a network node associated with a first radio access technology, a first packet from a node associated with a second radio access technology, the second radio access technology comprising a wireless local area network, wherein the first packet comprises a first control message from a UE configured for communications via the first radio access technology and the second radio access technology; and transmitting, to the node associated with the second radio access technology, a second packet comprising a second control message for establishing a connection between the network node and the UE over a communication link associated with the second radio access technology based at least in part on decoding the first control message.
Aspect 22: The method of aspect 21, wherein the first packet is received via a user plane, the method further comprising: receiving the first packet via a general packet radio service (GRPS) tunneling protocol-U (GTP-U) tunnel from the node, wherein the first packet comprises a tunnel endpoint identifier (TEID) allocated to the UE.
Aspect 23: The method of aspect 22, wherein transmitting the second packet comprising the second control message comprises: transmitting the second packet via the GTP-U tunnel to the node, wherein a destination TEID of the second packet comprises the TEID allocated to the UE.
Aspect 24: The method of any of aspects 21 through 23, further comprising: encapsulating the second control message in a radio resource control container, wherein the second packet comprises the control container.
Aspect 25: The method of any of aspects 21 through 24, further comprising: receiving, from the node, a third packet comprising a third control message, the third control message comprising a radio resource setup complete message, wherein the connection between the network node and the UE is established over the communication link based at least in part on the third control message.
Aspect 26: The method of any of aspects 21 through 25, wherein transmitting the second packet comprising the second control message comprises: determining an address of the UE, the address comprising a medium access control (MAC) address, or an Internet protocol (IP) address, or a UE association identifier, or any combination thereof; and transmitting the second packet including the address of the UE.
Aspect 27: A method for wireless communication, comprising: receiving, by a node associated with a first radio access technology, a first packet from a UE configured for communications via the first radio access technology and a second radio access technology, the first radio access technology comprising a wireless local area network, wherein the first packet comprises a first control message requesting establishment of a connection between the UE and a network node associated with the second radio access technology; and transmitting, to the network node associated with the second radio access technology, a second packet comprising the first control message for establishing the connection between UE and the network node based at least in part on receiving the first packet.
Aspect 28: The method of aspect 27, wherein transmitting the second packet comprising the first control message comprises: determining an address of the UE, the address comprising a medium access control (MAC) address, or an Internet protocol (IP) address, or a UE association identifier, or any combination thereof, and transmitting the second packet including the address of the UE.
Aspect 29: The method of any of aspects 27 through 28, wherein the second packet is transmitted via a user plane, the method further comprising: allocating a tunnel endpoint identifier (TEID) to the UE; and transmitting the second packet via a general packet radio service (GRPS) tunneling protocol-user (GTP-U) tunnel to the network node associated with the second radio access technology, wherein the second packet comprises the TEID allocated to the UE.
Aspect 30: An apparatus for wireless communication, comprising a processor; memory coupled with the processor; and instructions stored in the memory and executable by the processor to cause the apparatus to perform a method of any of aspects 1 through 20.
Aspect 31: An apparatus for wireless communication, comprising at least one means for performing a method of any of aspects 1 through 20.
Aspect 32: A non-transitory computer-readable medium storing code for wireless communication, the code comprising instructions executable by a processor to perform a method of any of aspects 1 through 20.
Aspect 33: An apparatus for wireless communication, comprising a processor; memory coupled with the processor; and instructions stored in the memory and executable by the processor to cause the apparatus to perform a method of any of aspects 21 through 26.
Aspect 34: An apparatus for wireless communication, comprising at least one means for performing a method of any of aspects 21 through 26.
Aspect 35: A non-transitory computer-readable medium storing code for wireless communication, the code comprising instructions executable by a processor to perform a method of any of aspects 21 through 26.
Aspect 36: An apparatus for wireless communication, comprising a processor; memory coupled with the processor; and instructions stored in the memory and executable by the processor to cause the apparatus to perform a method of any of aspects 27 through 29.
Aspect 37: An apparatus for wireless communication, comprising at least one means for performing a method of any of aspects 27 through 29.
Aspect 38: A non-transitory computer-readable medium storing code for wireless communication, the code comprising instructions executable by a processor to perform a method of any of aspects 27 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication, comprising:
transmitting, by a user equipment (UE), a first packet to a node that is associated with a first radio access technology comprising a wireless local area network, wherein the first packet comprises a first control message requesting establishment of a connection with a network node;
receiving, from the node, a second packet in response to the first control message, wherein the second packet comprises a second control message for establishing the connection between the UE and the network node; and
establishing the connection with the network node over a communication link associated with the first radio access technology based at least in part on the second control message.

2. The method of claim 1, further comprising:
transmitting, to the node, a third packet comprising a third control message, wherein the connection with the network node is established over the communication link based at least in part on the third control message.

3. The method of claim 2, wherein the third control message comprises a radio resource control setup complete message.

4. The method of claim 1, further comprising:
encapsulating the first control message in a radio resource control container, wherein the first packet comprises the radio resource control container.

5. The method of claim 1, wherein transmitting the first packet to the node comprises:
determining an address of the node; and
transmitting the first packet having an address field that includes a destination address comprising the address of the node.

6. The method of claim 5, wherein the address of the node comprises a medium access control (MAC) address, or an Internet protocol (IP) address, or any combination thereof.

7. The method of claim 1, wherein transmitting the first packet to the node comprises:
determining an address of the network node; and
transmitting the first packet having an address field that includes a destination address comprising the address of the network node.

8. The method of claim 7, wherein the address of the network node comprises a medium access control (MAC) address, or an Internet protocol (IP) address, or any combination thereof.

9. The method of claim 1, wherein transmitting the first packet to the node comprises:
determining that one or more coverage conditions have been satisfied, wherein the one or more coverage conditions comprise the UE being outside a coverage of a second radio access technology associated with the network node, or the coverage of the second radio access technology satisfying a threshold, or a signal quality of the first radio access technology being greater than a signal quality of the second radio access technology, or any combination thereof; and
transmitting the first packet comprising the first control message based at least in part on determining that the one or more coverage conditions have been satisfied.

10. The method of claim 1, wherein transmitting the first packet to the node comprises:
identifying policy information configuring the UE to transmit the first packet to the node, the policy information being configured per service, or per cell type, or per application, or per network slice, or any combination thereof; and
transmitting the first packet comprising the first control message based at least in part on the policy information.

11. The method of claim 10, further comprising:
receiving non-access stratum signaling configuring the policy information, wherein the policy information is identified based at least in part on the non-access stratum signaling.

12. The method of claim 10, wherein the policy information is preconfigured for the UE based at least in part on one or more subscriptions.

13. The method of claim 1, wherein transmitting the first packet to the node comprises:
determining that an access request transmitted to the network node has failed based at least in part on a random access failure, or access control barring, or a barred cell, or any combination thereof; and
transmitting the first packet comprising the first control message based at least in part on the failed access request.

14. The method of claim 1, wherein transmitting the first packet to the node comprises:
determining that a radio resource control connection with the network node has been rejected; and
transmitting the first packet comprising the first control message based at least in part on the rejected radio resource control connection.

15. The method of claim 1, wherein transmitting the first packet to the node comprises:
receiving an redirection indication from the network node, the redirection indication comprising an indication for the UE to request the establishment of the connection with the network node over the communication link; and
transmitting the first packet comprising the first control message based at least in part on the redirection indication.

16. The method of claim 1, wherein transmitting the first packet to the node comprises:
receiving, from the node, a paging message comprising an indication to request the establishment of the connection with the network node over the communication link; and
transmitting the first packet comprising the first control message based at least in part on the received paging message.

17. The method of claim 1, wherein the first control message comprises a radio resource control setup request message or a radio resource control resume request message, and wherein the second control message comprises a radio resource control setup message.

18. The method of claim 1, wherein the UE is configured to support communications via the first radio access technology and a second radio access technology.

19. The method of claim 18, wherein the second radio access technology comprises a new radio (NR) radio access technology, and wherein the network node comprises a centralized unit (CU).

20. The method of claim 1, wherein the node comprises an access point (AP), or a wireless local area network termination (WT), or any combination thereof.

21. A method for wireless communication, comprising:
receiving, by a network node associated with a first radio access technology, a first packet from a node associated with a second radio access technology, the second radio access technology comprising a wireless local area network, wherein the first packet comprises a first control message from a user equipment (UE) configured for communications via the first radio access technology and the second radio access technology;
and
transmitting, to the node associated with the second radio access technology, a second packet comprising a second control message for establishing a connection between the network node and the UE over a communication link associated with the second radio access technology based at least in part on decoding the first control message.

22. The method of claim 21, wherein the first packet is received via a user plane, the method further comprising:
receiving the first packet via a general packet radio service (GRPS) tunneling protocol-U (GTP-U) tunnel from the node, wherein the first packet comprises a tunnel endpoint identifier (TEID) allocated to the UE.

23. The method of claim 22, wherein transmitting the second packet comprising the second control message comprises:
transmitting the second packet via the GTP-U tunnel to the node, wherein a destination TEID of the second packet comprises the TEID allocated to the UE.

24. The method of claim 21, further comprising:
encapsulating the second control message in a radio resource control container, wherein the second packet comprises the radio resource control container.

25. The method of claim 21, further comprising:
receiving, from the node, a third packet comprising a third control message, the third control message comprising a radio resource setup complete message, wherein the connection between the network node and the UE is established over the communication link based at least in part on the third control message.

26. The method of claim 21, wherein transmitting the second packet comprising the second control message comprises:
determining an address of the UE, the address comprising a medium access control (MAC) address, or an Internet protocol (IP) address, or a UE association identifier, or any combination thereof; and
transmitting the second packet including the address of the UE.

27. A method for wireless communication, comprising:
receiving, by a node associated with a first radio access technology, a first packet from a user equipment (UE) configured for communications via the first radio access technology and a second radio access technology, the first radio access technology comprising a wireless local area network, wherein the first packet comprises a first control message requesting establishment of a connection between the UE and a network node associated with the second radio access technology; and
transmitting, to the network node associated with the second radio access technology, a second packet comprising the first control message for establishing the connection between the UE and the network node based at least in part on receiving the first packet.

28. The method of claim 27, wherein transmitting the second packet comprising the first control message comprises:
determining an address of the UE, the address comprising a medium access control (MAC) address, or an Internet protocol (IP) address, or a UE association identifier, or any combination thereof; and
transmitting the second packet including the address of the UE.

29. The method of claim 27, wherein the second packet is transmitted via a user plane, the method further comprising:
allocating a tunnel endpoint identifier (TEID) to the UE; and
transmitting the second packet via a general packet radio service (GRPS) tunneling protocol-user (GTP-U) tunnel to the network node associated with the second radio access technology, wherein the second packet comprises the TEID allocated to the UE.

30. An apparatus for wireless communication, comprising:
a processor; and
memory coupled with the processor, the memory having stored instructions which are executable by the processor to cause the apparatus to:
transmit, by a user equipment (UE), a first packet to a node that is associated with a first radio access technology comprising a wireless local area network, wherein the first packet comprises a first control message requesting establishment of a connection with a network node;
receive, from the node, a second packet in response to the first control message, wherein the second packet comprises a second control message for establishing the connection between the UE and the network node; and
establish the connection with the network node over a communication link associated with the first radio access technology based at least in part on the second control message.
